(19) United States
(12) Patent Application Publication
(10) Pub. No.: US 2005/0141764 A1
(43) Pub. Date: Jun. 30, 2005

(54) Pattern analysis method and pattern analysis apparatus

(75) Inventors: Yoko Tohyama, Kyoto (JP); Mitsumi Ito, Kyoto (JP)

Correspondence Address: MCDERMOTT WILL & EMERY LLP, 600 13TH STREET, N.W., WASHINGTON, DC, 20005-3096, US

(73) Assignee: MATSUSHITA ELECTRIC INDUSTRIAL CO., LTD.

(21) Appl. No.: 10/995,356

(22) Filed: Nov. 24, 2004

(30) Foreign Application Priority Data
Nov. 26, 2003 (JP) 2003-395242
May 10, 2004 (JP) 2004-139726

(51) Int. Cl. G06K 9/00; G06K 9/46

(52) U.S. Cl. 382/181; 382/203

(57) ABSTRACT

A pattern analysis method includes: a first step of preparing pattern layout data including a plurality of first regions and a plurality of second regions; a second step of selecting either said plurality of first regions or said plurality of second regions as a target region in which a critical area of said pattern layout data is to be calculated; and a third step of extracting, from said target region, rectangular regions each having a width within a given range. The method further includes; a fourth step of obtaining a total area of said rectangular regions; and a fifth step of calculating said critical area by using said total area.

### CROSS-REFERENCE TO RELATED APPLICATIONS

This application claims priority under 35 U.S.C. §119 on patent application No. 2003-395242 filed in Japan on Nov. 26, 2003 and No. 2004-139726 filed in Japan on May 10, 2004, the entire contents of which are hereby incorporated by reference.

### BACKGROUND OF THE INVENTION

The present invention relates to a pattern analysis method and a pattern analysis apparatus employed for obtaining a yield of patterns, and more particularly, it relates to a pattern analysis method and a pattern analysis apparatus employed in fabrication of electronic devices such as semiconductor devices.

In the fabrication of semiconductor devices such as LSIs, the cost of the semiconductor devices can be lowered by obtaining a large number of good LSIs from one semiconductor substrate (semiconductor wafer), namely, by improving the yield. The known factors for lowering the yield are, for example, defects such as particles causing a short-circuit or open of an interconnect in respective steps (particularly, a wiring step) of the LSI fabrication process. The density of defects such as particles can be estimated on the basis of, for example, dust distribution information of a cleaning room where the LSIs are fabricated. As the chip size of the LSIs is larger, the number of defects such as particles caused in one LSI chip is increased, and hence, the yield is lowered.

It is significant for estimating the fabrication cost of LSIs to calculate such a yield of LSIs at the design stage. Therefore, in a conventional technique where the yield of a new type of products of semiconductor devices such as LSIs is calculated on trial, the yield is calculated by using a model formula such as a seeds model (see Formula 1 below) or a Poisson model (see Formula 2 below) in consideration of the chip size.
Y=1/(1+A·D) Formula 1:
Y=exp(−A·D) Formula 2:

In these formulas, Y is the yield, A is a chip area (cm²) and D is a defect density (/cm²). Also, when the chip size (the chip area) is the same, the yields respectively calculated in accordance with these Formulas 1 and 2 are the same.

However, since circuits are recently complicated as a result of increase of the degree of integration and improved performance of the circuits, even when the chip sizes are the same, substantially the same yield cannot be obtained in some of different types of products. This is for the following reason: Even when the chip sizes are the same, there is a difference in probability of occurrence of defects in an interconnect forming step between, for example, a type of products with a high interconnect density and a type of products with a low interconnect density. This difference makes considerable a difference in the yield between these types.

As a countermeasure, for example, a method using, for the calculation of the yield, a defect distribution curve and a critical area where a defect actually causes failure has been proposed (see Non-patent documents 1 through 3 below). A critical area is an index for quantitatively indicating the degree that a defect causes a short-circuit or disconnection derived from open, and is equal to a sum of areas in which defects actually cause failure in a chip.

The comprehensive yield of the process is generally expressed by a product of a systematic yield Ys determined depending upon a system and a yield YR determined depending upon random defects. The yield depending upon the random defects, and more specifically, a yield YRC depending upon a critical area, is expressed by using, for example, the Poisson distribution model as the following Formula 3:
YRC=exp(−DD·Ac) Formula 3:
wherein DD is the number of defects which can cause a fault per unit area of a critical area and Ac is the critical area.

Furthermore, Non-patent document 1 discloses that a critical area for a short-circuit between interconnects is expressed as follows:
Ac(x)=0(0<x<s)
Ac(x)=L·(x−s)(s≦x<∞) Formula 4-1:
wherein x is the size of a defect, s is a space (width) between interconnects, and L is a total length of the interconnects.

Moreover, Non-patent document 3 discloses that a critical area for a short-circuit between interconnects is expressed as follows:
Ac(x)=0(0<x<s)
Ac(x)=L·(x−s)(s≦x<2s+1)
Ac(x)=L·(s+1)(2s+1≦x<∞)
wherein x is the size of a defect, s is a space (width) between interconnects, 1 is an interconnect width and L is a total length of the interconnects.

As shown in Formulas 4-1 and 4-2, a critical area has a value depending upon the size of a defect.

FIGS. 12A and 12B are diagrams (plan views of an interconnect pattern seen from above) for explaining the critical area. In the case where a defect-related particle 11 has a size smaller than a space 13 between interconnects 12 (namely, the width of a space region therebetween, which is hereinafter referred to as the interconnect space) as shown in FIG. 12A, the particle 11 does not cause a short-circuit between the interconnects. However, in the case where the defect-related particle 11 has a size larger than an interconnect space 14 between interconnects 12 (namely, the width of a space region therebetween) as shown in FIG. 12B, the particle 11 may cause a short-circuit between the interconnects. For example, in the case where the particle has a diameter of 0.3 μm, the sum of areas obtained through the calculation using Formula 4-2 or the like on space regions with an interconnect space of 0.3 μm or less corresponds to the critical area for a short-circuit between the interconnects with respect to the particle having a diameter of 0.3 μm.

FIG. 13 is a diagram for showing the correlations of the diameter of a defect-related particle with a defect density and a critical area. In FIG. 13, the abscissa indicates the diameter of a defect-related particle and the ordinate indicates the defect density and the critical area. As shown in FIG. 13, as the diameter of the particle is larger, the defect density tends to be smaller. On the other hand, although the critical area is increased as the diameter of the particle is larger, when the diameter of the particle exceeds a given value, the degree of the increase of the critical area is smaller.

At this point, when the defect density and the critical area obtained about a particle having a diameter x are respectively indicated by D(x) and Ac(x), “DD-Ac” on the right hand side of Formula 3 is expressed as follows:
DD·Ac=∫D(x)·Ac(x)dx

Accordingly, when the values of D(x) and Ac(x) are obtained, the yield YRC can be estimated.

It is reported that the calculation method for such a critical area is roughly divided into two methods, specifically, one of which is a method employing a geometric operation (for example, see Patent document 1 and non-patent documents 4 and 5) and the other of which is a method employing Monte Carlo simulation (for example, see Patent documents 2 and 3 and non-patent document 5).

In the method employing a geometric operation, the width of an interconnect graphic is increased by a size corresponding to the radius of a particle, and a portion where resultant adjacent interconnects are overlapped is defined as a critical area.

In the method employing Monte Carlo simulation, particles with various diameters are generated, and when these particles connect adjacent interconnects to each other, it is regarded that a short-circuit is caused between the interconnects. With a large number of such virtual particles generated, the proportion of particles that cause a short-circuit is calculated. The thus calculated value corresponds to an approximate value of a value obtained by normalizing a critical area by a chip area.

The factors for lowering the yield are not only a short-circuit or open of interconnects derived from a defect such as a particle described above, namely, the yield lowering factors depending upon a critical area, but also contact failure between multilayered interconnects. FIGS. 14A and 14B are diagrams for explaining the contact failure, and specifically, FIG. 14A is a cross-sectional view of a multilayer interconnect structure with no contact failure and FIG. 14B is a cross-sectional view of a multilayer interconnect structure with contact failure. As shown in FIG. 14A, an interlayer insulating film 22 is provided on a lower interconnect 21, and an upper interconnect 23 is provided on the interlayer insulating film 22. The lower interconnect 21 and the upper interconnect 23 are electrically connected to each other through a contact plug 25 filled in a via hole 24 formed in the interlayer insulating film 22. However, in the case where an insulating film portion 22a remains below the via hole 24 owing to formation failure of the via hole 24 as shown in FIG. 14B, the lower interconnect 21 and the upper interconnect 23 are not electrically connected to each other, and thus, the contact failure occurs.

Herein, a via hole for connecting upper and lower interconnects to each other or a contact hole for connecting an interconnect and a diffusion layer or the like to each other together with a plug formed in such a hole are designated as a via or a contact.

The contact failure includes, apart from the connection failure of a contact described with reference to FIGS. 14A and 14B, short-circuit failure between contacts occurring when the contacts (or vias) are near to each other at a given or less distance and these near contacts are connected to different nodes. FIGS. 15A through 15F are diagrams for showing an exemplified short-circuit caused between contacts for connecting a diffusion layer and an interconnect to each other, and specifically, are cross-sectional views for showing procedures for forming a plurality of contacts respectively connected to a plurality of diffusion regions formed on a substrate.

First, as shown in FIG. 15A, an interlayer insulating film 33 is formed on a plurality of diffusion regions 32a through 32d formed on a substrate 31. At this point, it is assumed that a crack 34 is caused on a part of the surface of the interlayer insulating film 33. The crack 34 is caused through CMP (Chemical Mechanical Polishing) or the like performed for planarizing the interlayer insulating film 33. Subsequently, as shown in FIG. 15B, a resist pattern 35 having openings in contact forming regions is formed on the interlayer insulating film 33, and the interlayer insulating film 33 is etched by using the resist pattern 35 as a mask. Thus, a plurality of contact holes 36a through 36d respectively reaching the diffusion regions 32a through 32d are formed in the interlayer insulating film 33. Thereafter, as shown in FIG. 15C, the resist pattern 35 is removed. Then, as shown in FIG. 15D, a metal film 37 of tungsten or the like is deposited within the contact holes 36a through 36d and on the interlayer insulating film 33. Next, as shown in FIG. 15E, a portion of the metal film 37 deposited outside the contact holes 36a through 36d, namely, a portion of the metal film 37 present above the surface of the interlayer insulating film 33, is removed. In this manner, a plurality of contact plugs 38a through 38d of tungsten or the like are respectively formed within the contact holes 36a through 36d. At this point, the metal film 37 remains in the crack 34. The metal film 37 remaining in the crack 34 cannot be completely removed through the CMP previously performed. Subsequently, as shown in FIG. 15F, a plurality of upper interconnects 40a through 40d are respectively formed on the contact plugs 38a through 38d. However, the metal film 37 remaining in the crack 34 causes a short-circuit between the contact plug 38a and the contact plug 38b, and therefore, a short-circuit is caused between the upper interconnect 40a and the upper interconnect 40b.

A yield YRV depending upon the above-described contact failure is expressed as follows:
YRV=exp(−λv·N) Formula 6:
wherein λv is fraction defective of vias and N is the number of vias. It is noted that the number of vias used in Formula 6 is different between calculation for formation (connection) failure of the vias and calculation for leakage (short-circuit) failure of the vias.

As described above, the comprehensive yield of the process can be calculated by obtaining the values DD and Xv in each principal masking procedure, calculating the yields YRC and YRV of each principal masking procedure by using the values, and obtaining a product of the thus calculated yields.

Patent document 1: Japanese Laid-Open Patent Publication No. 2002-163323

Patent document 2: Japanese Laid-Open Patent Publication No. 2002-156418

Patent document 3: Japanese Laid-Open Patent Publication No. 2001-344301

Non-patent document 1: C. H. Stapper, Modeling of Integrated Circuit defect Sensitivities, IBM J. Res. Develop., U.S.A., November 1983, Vol. 27, pp. 549-557

Non-patent document 2: C. H. Stapper, Modeling of defects in integrated circuit photographic patterns, IBM J. Res. Develop., U.S.A., July 1984, Vol. 28, pp. 461-475

Non-patent document 3: Jitendra Khare, Accurate Estimation of Defect-Related Yield Loss in Reconfigurable VLSI Circuits, IEEE JOURNAL OF SOLID-STATE CIRCUITS, U.S.A., February 1993, Vol. 28, pp. 146-156

Non-patent document 4: Pranab K. Nag, Hierarchical Extraction of Critical Area for Shorts in Very Large ICs, IEEE INTERNATIONAL WORKSHOP ON DEFECT AND FAULT TOLERANCE IN VLSI SYSTEMS, U.S.A., 1995, pp.19-27

Non-patent document 5: Charles H. Stapper, Integrated Circuit Yield Management and Yield Analysis: Development and Implementation, IEEE TRANSACTIONS ON SEMICONDUCTOR MANUFACTURING U.S.A., May 1995, Vol. 8, No. 2, pp.95-102

### SUMMARY OF THE INVENTION

However, in the case where the conventional critical area calculation method disclosed in, for example, Patent document 1 is applied to complicated interconnect patterns of LSIs with a recently increased degree of integration, it is necessary to calculate a critical area with defects classified into a large number of sizes, which is disadvantageously unpractical.

On the other hand, in the calculation of a yield in consideration of contact failure between multilayered interconnects, the probability of occurrence of contact failure is largely varied depending upon the number of vias for connecting the interconnects arranged in parallel between the interconnects. Therefore, even when the product of the total number of vias and the via fraction defective is simply obtained by Formula 6, the yield cannot be accurately calculated. Furthermore, there are some contact failure factors not depending upon the total number of vias arranged in parallel between interconnects (such as insufficient etching for forming a via hole), and therefore, it is necessary to perform the calculation on the basis of Formula 6 by setting the via fraction defective as fraction defective depending upon the number of vias grouped in consideration of details of each failure and by defining a counting method.

Furthermore, a specific example of the contact failure not depending upon the total number of vias is a short-circuit between contacts derived from a crack as described above. However, in the calculation of a yield in consideration of such short-circuit failure, a probability that a short-circuit is caused between vias away from each other can be ignored. Therefore, it is necessary to obtain the number of vias each spaced by a small distance from an adjacent via and connected to a node different from the adjacent via, namely, the number of different-node near vias each having an upper interconnect and a lower interconnect connected thereto being different nodes from an adjacent near vias. In addition, the calculation on the basis of Formula 6 should be performed by using the number of the different-node near vias and a probability that a short-circuit is caused between the different-node near vias.

In consideration of these conventional disadvantages, an object of the invention is providing a pattern analysis method and a pattern analysis apparatus in which a precise yield very close to a yield of actual products can be rapidly calculated even with respect to complicated patterns of a highly integrated LSI.

In order to achieve the object, the first pattern analysis method of this invention includes a first step of preparing pattern layout data including a plurality of first regions and a plurality of second regions; a second step of selecting either the plurality of first regions or the plurality of second regions as a target region in which a critical area of the pattern layout data is to be calculated; a third step of extracting, from the target region, rectangular regions each having a width within a given range; a fourth step of obtaining a total area of the rectangular regions; and a fifth step of calculating the critical area by using the total area.

In the first pattern analysis method, actual pattern layout data including the first regions corresponding to, for example, line portions and the second regions corresponding to, for example, space portions can be dealt with as simple combinations of a plurality of rectangular patterns having different widths. In other words, in consideration of the relationship between the width of each rectangular pattern and the size of a defect such as a particle, the critical area can be easily and accurately calculated by using the total area of the rectangular patterns.

The second pattern analysis method of this invention includes a first step of preparing pattern layout data including a plurality of first regions and a plurality of second regions; a second step of selecting either the plurality of first regions or the plurality of second regions as a target region in which a critical area of the pattern layout data is to be calculated and defining the rest of the plurality of first regions and the plurality of second regions not selected as a non-target region; a third step of extracting, from the target region, rectangular regions each having a width within a given range; a fourth step of extracting an adjacent region having a width within a given range from a portion of the non-target region in contact with the rectangular regions; a fifth step of increasing the width of the adjacent region by a given width in a direction toward an adjacent one of the rectangular regions; a sixth step of extracting portions where the adjacent region having been increased in the width and the rectangular regions are overlapped and obtaining a total area of the extracted portions; and a seventh step of calculating the critical area by using the total area.

In the second pattern analysis method, actual pattern layout data including the first regions corresponding to, for example, line portions and the second regions corresponding to, for example, space portions can be dealt with as simple combinations of a plurality of rectangular patterns having different widths. In other words, in consideration of the relationship between the width of each rectangular pattern and the size of a defect such as a particle, the critical area can be easily and accurately calculated by using the total area of the rectangular patterns. Furthermore, in the case of calculating a critical area with respect to one kind of these regions (for example, the first regions), the critical area is calculated in consideration of the widths of the other kind of regions (namely, the second regions). Therefore, as compared with the first pattern analysis method, the critical area calculated by the second pattern analysis method is improved in the accuracy.

The third pattern analysis method of this invention includes a first step of preparing pattern layout data including a plurality of first regions and a plurality of second regions; a second step of selecting either the plurality of first regions or the plurality of second regions as a target region in which a critical area of the pattern layout data is to be calculated; a third step of extracting, from the target region, first rectangular regions each having a width not smaller than a minimum width Xₘᵢₙ of the target region and smaller than a width X₁ corresponding to a sum of the width Xₘᵢₙ and a pitch ΔX; a fourth step of obtaining a total area S₁ of the first rectangular regions; a fifth step of reclassifying the first rectangular regions as a separate region from the target region after the fourth step; a sixth step, performed after the fifth step, of repeatedly performing procedures for extracting, from the target region, (n+1)th rectangular regions each having a width not smaller than a width Xₙ (wherein n is a natural number of 1 through t) and smaller than a width Xₙ₊₁ corresponding to a sum of the width Xₙ and the pitch ΔX, obtaining a total area Sₙ₊₁ of the (n+1)th rectangular regions, and reclassifying the (n+1)th rectangular regions as a separate region from the target region while incrementing n by 1 from 1 until the width Xₙ becomes equal to a given value Xₜ; a seventh step of obtaining a total area Sₜ₊₁ of remaining portions of the target region after the sixth step; and an eighth step of calculating the critical area by using the total areas after the seventh step.

In the third pattern analysis method, actual pattern layout data including the first regions corresponding to, for example, line portions and the second regions corresponding to, for example, space portions can be dealt with as simple combinations of a plurality of rectangular patterns having different widths. In other words, in consideration of the relationship between the width of each rectangular pattern and the size of a defect such as a particle, the critical area can be easily and accurately calculated by using the total area of the rectangular patterns. Accordingly, when the critical area obtained by the third pattern analysis method of the invention is used in yield calculation, a precise yield very close to the yield of actual products can be rapidly calculated even with respect to complicated patterns of a highly integrated LSI. It is noted that a rectangular region herein means not only a region in the shape of a rectangle but also a region in the shape of a square. Also, the width of a rectangular region means the length of a shorter side when the region is in the shape of a rectangle and means the length of one side when it is in the shape of a square.

In the third pattern analysis method, the pitch ΔX is preferably increased as the width Xₙ is increased in the sixth step.

Thus, the calculation speed can be increased without degrading the calculation accuracy in the critical area calculation. In this case, the calculation speed can be further increased by keeping the pitch ΔX at a constant value as far as the width Xₙ falls within a given range in the sixth step. Specifically, in the sixth step, when the width Xₙ is smaller than a value twice as large as the minimum width Xₘᵢₙ, the pitch ΔX may be set to a value 1/10 as large as the minimum width Xₘᵢₙ, when the width Xₙ is not smaller than the value twice as large as the minimum width Xₘᵢₙ and smaller than a value five times as large as the minimum width Xₘᵢₙ, the pitch ΔX may be set to a value ⅕ as large as the minimum width Xₘᵢₙ, when the width Xₙ is not smaller than the value five times as large as the minimum width Xₘᵢₙ and smaller than a value ten times as large as the minimum width Xₘᵢₙ, the pitch ΔX may be set to a value equivalent to the minimum width Xₘᵢₙ, and when the width Xₙ is not smaller than the value ten times as large as the minimum width Xₘᵢₙ and smaller than a value a hundred times as large as the minimum width Xₘᵢₙ, the pitch ΔX may be set to the value ten times as large as the minimum width Xₘᵢₙ.

The fourth pattern analysis method of this invention includes a first step of preparing pattern layout data including a plurality of first regions and a plurality of second regions; a second step of selecting either the plurality of first regions or the plurality of second regions as a target region in which a critical area of the pattern layout data is to be calculated and defining the rest of the plurality of first regions and the plurality of second regions not selected as a non-target region; a third step of extracting, from the target region, first rectangular regions each having a width not smaller than a minimum width Xₘᵢₙ of the target region and smaller than a width X₁ corresponding to a sum of the width Xₘᵢₙ and a pitch ΔX; a fourth step of extracting a first adjacent region Z_{0,0} having a minimum width Yₘᵢₙ of the non-target region from a portion of the non-target region in contact with the first rectangular regions; a fifth step of increasing a width of the first adjacent region Z_{0,0} by the width X₁ in a direction toward an adjacent one of the first rectangular regions; a sixth step of extracting portions where the first adjacent region Z_{0,0} having been increased in the width and the first rectangular regions are overlapped and obtaining a total area A_{0,0} of the extracted portions; a seventh step of reclassifying the extracted portions as a separate region from the first rectangular regions after the sixth step; an eighth step, performed after the seventh step, of repeatedly performing procedures for extracting, from a portion of the non-target region in contact with the first rectangular regions, a mth adjacent region Z_{0,m} having a width not larger than a width Yₘ corresponding to a sum of a width Yₘ₋₁ of the non-target region (wherein m is a natural number; and a width Y₀ corresponds to the minimum width Yₘᵢₙ) and a pitch ΔY, increasing a width of the mth adjacent region Z_{0,m} by the width X₁ in a direction toward an adjacent one of the first rectangular regions, extracting portions where the mth adjacent region Z_{0,m} having been increased in the width and the first rectangular regions are overlapped, obtaining a total area A_{0,m} of the extracted portions, and reclassifying the extracted portions as a separate region while incrementing m by 1 from 1 until m becomes equal to a given value t; a ninth step of obtaining a total area A_{0,t+1} of remaining portions of the first rectangular regions after the eighth step; a tenth step, performed after the ninth step, of repeatedly performing procedures for extracting, from the target region, (n+1)th rectangular regions each having a width not smaller than a width Xₙ (wherein n is a natural number) and smaller than a width Xₙ₊₁ corresponding to a sum of the width Xₙ and the pitch ΔX and successively obtaining total areas A_{n,0} through A_{n,1+1} of the (n+1)th rectangular regions in a similar manner as in the fourth through ninth steps while incrementing n by 1 from 1 until n becomes equal to a given value (u−1); an eleventh step, performed after the tenth step, of successively obtaining total areas A_{u,0} through A_{u,t+1} of remaining portions of the target region in a similar manner as in the fourth through ninth steps; and a twelfth step of calculating the critical area by using the total areas after the eleventh step.

In the fourth pattern analysis method, actual pattern layout data including the first regions corresponding to, for example, line portions and the second regions corresponding to, for example, space portions can be dealt with as simple combinations of a plurality of rectangular patterns having different widths. In other words, in consideration of the relationship between the width of each rectangular pattern and the size of a defect such as a particle, the critical area can be easily and accurately calculated by using the total area of the rectangular patterns. Furthermore, in the case of calculating a critical area with respect to one kind of these regions (for example, the first regions), the critical area is calculated in consideration of the widths of the other kind of regions (namely, the second regions). Therefore, as compared with the third pattern analysis method, the critical area calculated by the fourth pattern analysis method is improved in the accuracy. Accordingly, when the critical area obtained by the fourth pattern analysis method of the invention is used in yield calculation, a precise yield very close to the yield of actual products can be rapidly calculated even with respect to complicated patterns of a highly integrated LSI.

In the fourth pattern analysis method, the pitch ΔX is preferably increased as the width Xₙ is increased in the tenth step, and the pitch ΔY is preferably increased as the width Yₘ is increased in the eighth step.

Thus, the calculation speed can be increased without degrading the calculation accuracy in the critical area calculation. In this case, the calculation speed can be further increased by keeping the pitch ΔX at a constant value as far as the width Xₙ falls within a given range in the tenth step, and keeping the pitch ΔY at a constant value as far as the width Yₘ falls within a given range in the eighth step. Specifically, in the tenth step, when the width Xₙ is smaller than a value twice as large as the minimum width Xₘᵢₙ, the pitch ΔX is set to a value 1/10 as large as the minimum width Xₘᵢₙ, when the width Xₙ is not smaller than the value twice as large as the minimum width Xₘᵢₙ and smaller than a value five times as large as the minimum width Xₘᵢₙ, the pitch ΔX may be set to a value ⅕ as large as the minimum width Xₘᵢₙ, when the width Xₙ is not smaller than the value five times as large as the minimum width Xₘᵢₙ and smaller than a value ten times as large as the minimum width Xₘᵢₙ, the pitch ΔX may be set to a value equivalent to the minimum width Xₘᵢₙ, and when the width Xₙ is not smaller than the value ten times as large as the minimum width Xₘᵢₙ and smaller than a value a hundred times as large as the minimum width Xₘᵢₙ, the pitch ΔX may be set to the value ten times as large as the minimum width Xₘᵢₙ, and in the eight step, when the width Yₘ is smaller than a value twice as large as the minimum width Yₘᵢₙ, the pitch ΔY may be set to a value 1/10 as large as the minimum width Xₘᵢₙ, when the width Yₘ is not smaller than the value twice as large as the minimum width Xₘᵢₙ and smaller than a value five times as large as the minimum width Yₘᵢₙ, the pitch ΔY may be set to a value ⅕ as large as the minimum width Yₘᵢₙ, when the width Yₘ is not smaller than the value five times as large as the minimum width Yₘᵢₙ and smaller than a value ten times as large as the minimum width Yₘᵢₙ, the pitch ΔY may be set to a value equivalent to the minimum width Yₘᵢₙ, and when the width Yₘ is not smaller than the value ten times as large as the minimum width Yₘᵢₙ and smaller than a value a hundred times as large as the minimum width Yₘᵢₙ, the pitch ΔY may be set to the value ten times as large as the minimum width Yₘᵢₙ.

The third or fourth pattern analysis method preferably further includes, between the second step and the third step, a step of excluding, from the target region, a region in which a dummy pattern of the pattern layout data is disposed.

Thus, the critical area can be accurately calculated with the dummy pattern not related to the yield of actual products excluded, and therefore, a more highly precise yield close to the yield of the actual products can be calculated by using the critical area.

The first pattern analysis apparatus of the invention includes a storage device for storing, as CAD data, mask data used as pattern layout data for which a critical area is to be obtained; operating means for executing the third or fourth pattern analysis method of the invention by using the mask data read from the storage device; and outputting means for outputting information of the critical area obtained by the operating means.

In other words, the first pattern analysis apparatus is a pattern analysis apparatus for practicing the third or fourth pattern analysis method, and therefore, the aforementioned effects can be attained.

The fifth pattern analysis method of this invention for calculating a number of vias to be used in yield calculation in consideration of contact failure between multilayered interconnects, includes a first step of preparing first interconnect pattern layout data and second interconnect pattern layout data that are respectively pattern layouts of a first interconnect disposed in a lower layer and a second interconnect disposed in an upper layer of the multilayered interconnects and contact pattern layout data that is a pattern layout of vias for connecting the first interconnect and the second interconnect to each other; a second step of extracting overlap regions in each of which a line portion of the first interconnect of the first interconnect pattern layout data and a line portion of the second interconnect of the second interconnect pattern layout data are overlapped; a third step of extracting, from the overlap regions extracted in the second step, target overlap regions each including merely one of the vias; a fourth step of obtaining a total area S of the vias included in each of the target overlap regions extracted in the third step; and a fifth step of obtaining a number N₁ of single connection vias by dividing the total area S by an area S₁ per via.

In the fifth pattern analysis method, after extracting the overlap regions where the line portion of the lower interconnect and the line portion of the upper interconnect are overlapped, target overlap regions each including merely one via are extracted from the extracted overlap regions. Thereafter, the total area S of the vias included in all the extracted target overlap regions is obtained, and the number N₁ of single connection vias is obtained by dividing the total area S by the area S₁ per via. Therefore, the number of vias singly connecting the lower interconnect and the upper interconnect to each other, namely, the number of single connection vias, can be efficiently and accurately calculated. Accordingly, when the number of single connection vias obtained by the fifth pattern analysis method of the invention is used together with, for example, via fraction defective determined by the process for calculating a yield, a highly precise yield very close to the yield of actual products can be rapidly calculated even with respect to complicated patterns of a highly integrated LSI. It is noted that an area of a via means a contact area between a via and an interconnect connected to the via on the layout data.

In the fifth pattern analysis method, preferably, the multilayered interconnects further include a third interconnect disposed below the first interconnect, in the fourth step, overlap states between other vias for connecting the first interconnect and the third interconnect to each other and the vias included in the target overlap regions are classified into N (wherein N is a natural number) kinds of overlap states and N kinds of total areas S are obtained respectively in accordance with the N kinds of overlap states, and in the fifth step, N kinds of numbers N₁ of single connection vias are obtained respectively in accordance with the N kinds of overlap states by dividing the N kinds of total areas S respectively by the area S₁ per via.

Thus, with respect to a multilayer interconnect structure including three or more layers, the number of single connection vias can be calculated individually in consideration of a failure factor depending upon the overlap state between a lower via and an upper via used in the structure. Therefore, a more highly precise yield can be calculated by using this number of single connection vias.

The sixth pattern analysis method of this invention for calculating a number of vias to be used in yield calculation in consideration of contact failure between multilayered interconnects, includes a first step of preparing first interconnect pattern layout data and second interconnect pattern layout data that are respectively pattern layouts of first interconnects disposed in a lower layer and second interconnects disposed in an upper layer of the multilayered interconnects and contact pattern layout data that is a pattern layout of vias for connecting the first interconnects and the second interconnects to each other; a second step of extracting, from the vias of the contact pattern layout data, near vias each near to another via spaced at a distance smaller than a given value; a third step of extracting, from the near vias extracted in the second step, different-node near vias each of which is connected to a different first interconnect and a different second interconnect connected from another via near to the vias; a fourth step of obtaining a total area S of the different-node near vias extracted in the third step; and a fifth step of obtaining a number N₂ of different-node near vias by dividing the total area S by an area S₁ per via.

In the sixth pattern analysis method, out of the vias used for connecting the lower interconnects and the upper interconnects to each other, different-node near vias each of which is spaced from an adjacent via at a distance not larger than the given value and has a lower interconnect and an upper interconnect connected thereto being different nodes from the adjacent via are extracted. Thereafter, the total area S of all the extracted different-node near vias is obtained, and the number N₂ of different-node near vias is obtained by dividing the total area S by the area S₁ per via. Therefore, the total number of vias in which leakage (short-circuit) with adjacent vias may occur, namely, the number of different-node near vias, can be efficiently and accurately calculated. Accordingly, when the number of different-node near vias obtained by the sixth pattern analysis method is used for calculating a yield together with, for example, via leakage fraction defective determined by the process, a highly precise yield very close to the yield of actual products can be rapidly calculated even with respect to complicated patterns of a highly integrated LSI.

The fifth or sixth pattern analysis method preferably further includes, between the first step and the fourth step, a step of excluding a region where a dummy pattern is disposed from the pattern layout data, the overlap regions or the target overlap regions.

Thus, the number of single connection vias or different-node near vias can be accurately calculated with the dummy pattern not related to the yield of actual products excluded, and therefore, a more highly precise yield close to the yield of the actual products can be calculated by using the number of single connection vias or different-node near vias.

In the fifth or sixth pattern analysis method, the first interconnect disposed in the lower layer may be, for example, a diffusion layer of a transistor, or the second interconnect disposed in the upper layer may be, for example, an electrode of a capacitative element. In other words, the fifth or sixth pattern analysis method is applicable to contacts instead of vias.

The second pattern analysis apparatus of the invention includes a storage device for storing, as CAD data, mask data used as pattern layout data for which a yield in consideration of contact failure between multilayered interconnects is to be calculated; operating means for executing the fifth or sixth pattern analysis method by using the mask data read from the storage device; and outputting means for outputting information of the number of single connection vias obtained by the operating means.

In other words, the second pattern analysis apparatus is a pattern analysis apparatus for practicing the fifth or sixth pattern analysis method of the invention, and hence, the aforementioned effects can be attained.

As described so far, according to the present invention, the critical area, the number of single connection vias or the number of different-node near vias can be easily and accurately calculated. Therefore, when the critical area, the number of single connection vias or the number of different-node near vias is used for calculating a yield, a highly precise yield very close to the yield of actual products can be rapidly calculated even with respect to complicated patterns of a highly integrated LSI. Accordingly, the pattern analysis method and the pattern analysis apparatus according to the invention are particularly useful in the calculation of a yield of patterns.

### BRIEF DESCRIPTION OF THE DRAWINGS

FIG. 1 is a diagram of an exemplified architecture of a pattern analysis apparatus according to Embodiment 1, 2 or 4 of the invention;

FIG. 2 is a flowchart for a pattern analysis method according to Embodiment 1 of the invention;

FIGS. 3A, 3B, 3C, 3D and 3E are interconnect pattern layout diagrams for explaining respective steps of the flowchart of FIG. 2;

FIG. 4A is a diagram for showing a distribution of a total area of rectangular patterns against a space width obtained by the pattern analysis method of Embodiment 1 of the invention and FIG. 4B is a diagram for showing correlation between a critical area obtained by the pattern analysis method of Embodiment 1 and the diameter of a particle;

FIG. 5 is a flowchart for a pattern analysis method according to Embodiment 2 of the invention;

FIG. 6A is a diagram for showing a distribution of a total area of rectangular patterns against a space width obtained by the pattern analysis method of Embodiment 2 of the invention and FIG. 6B is a diagram for showing correlation between a critical area obtained by the pattern analysis method of Embodiment 2 and the diameter of a particle;

FIGS. 7A and 7B are diagrams for explaining a “single connection via” and “contact failure”;

FIG. 8 is a diagram for showing an exemplified architecture of a pattern analysis apparatus according to Embodiment 3 or 5 of the invention;

FIG. 9 is a flowchart for a pattern analysis method according to Embodiment 3 of the invention;

FIGS. 10A, 10B, 10C and 10D are interconnect pattern layout diagrams for explaining respective steps of the flowchart of FIG. 9;

FIGS. 11A, 11B and 11C are diagrams for explaining classification of overlap states of vias in a multilayer interconnect structure including three or more layers;

FIGS. 12A and 12B are diagrams for explaining a critical area (i.e., a diagram for showing the relationship between an interconnect pattern and a particle);

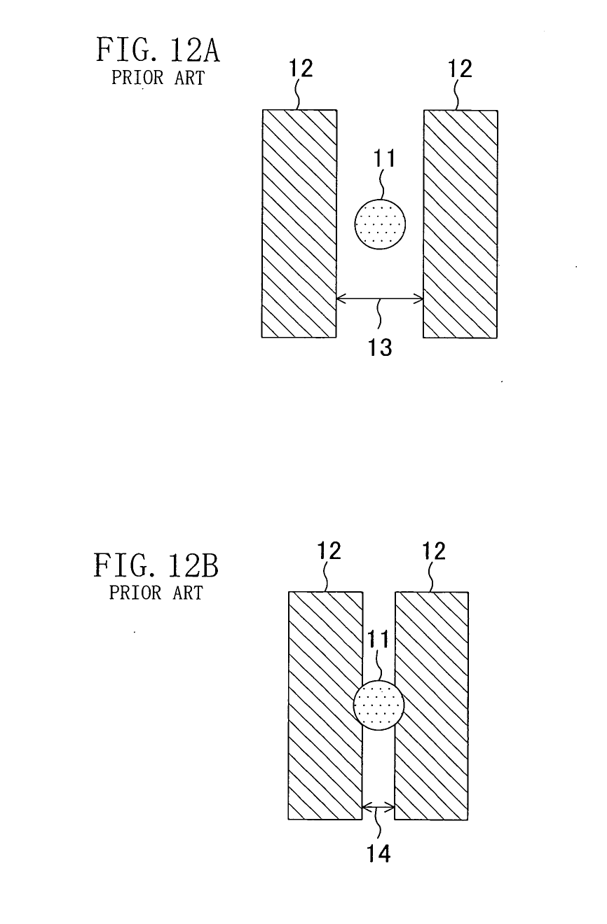

FIG. 13 is a diagram for showing correlation of the diameter of a failure-related particle with a defect density and a critical area;

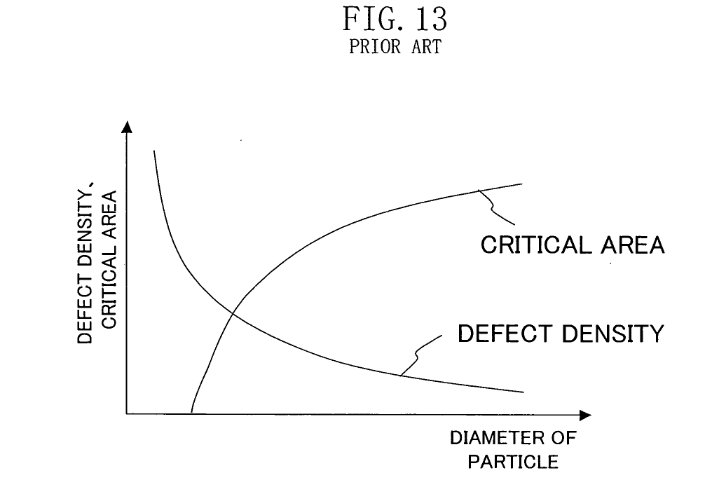

FIGS. 14A and 14B are diagrams for explaining contact failure;

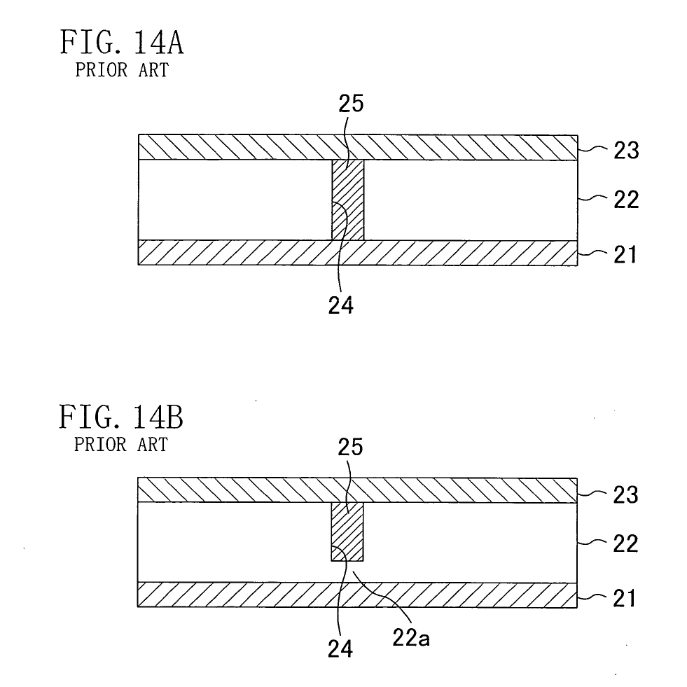

FIGS. 15A, 15B, 15C, 15D, 15E and 15F are diagrams for explaining failure derived from a short-circuit caused between contacts;

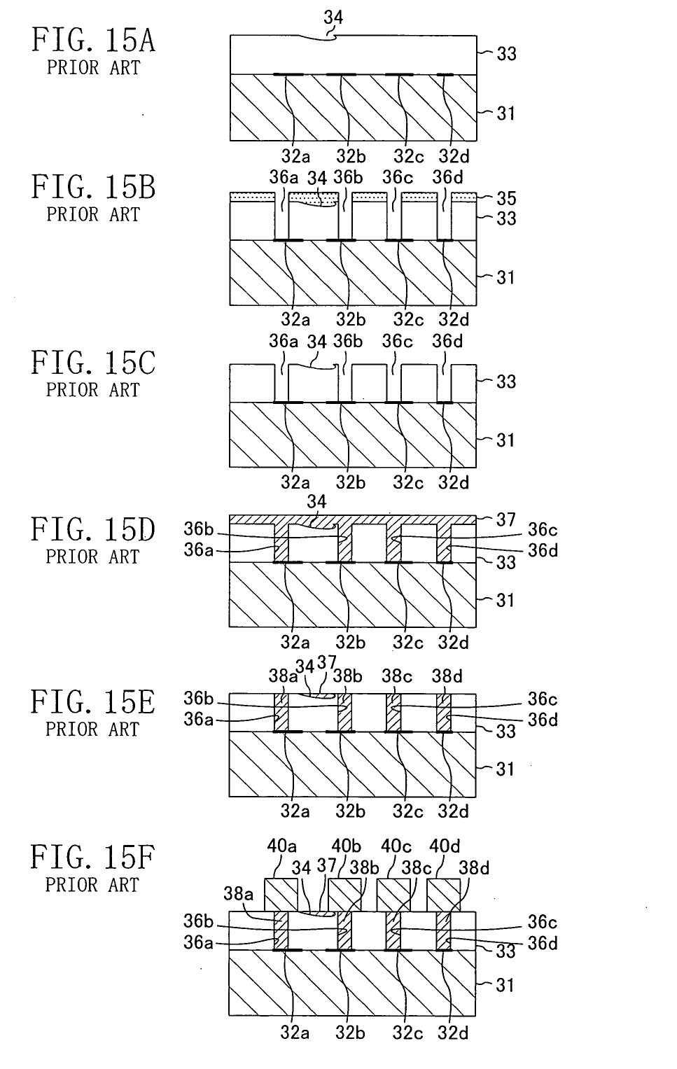

FIG. 16 is a flowchart for a pattern analysis method according to Embodiment 4 of the invention;

FIGS. 17A, 17B, 17C, 17D and 17E are interconnect pattern layout diagrams for explaining steps of the flowchart of FIG. 16;

FIGS. 18A, 18B, 18C, 18D and 18E are interconnect pattern layout diagrams for explaining other steps of the flowchart of FIG. 16;

FIGS. 19A, 19B, 19C, 19D and 19E are interconnect pattern layout diagrams for explaining still other steps of the flowchart of FIG. 16;

FIGS. 20A, 20B, 20C and 20D are interconnect pattern layout diagrams for explaining still other steps of the flowchart of FIG. 16;

FIGS. 21A, 21B, 21C and 21D are interconnect pattern layout diagrams for explaining still other steps of the flowchart of FIG. 16;

FIGS. 22A, 22B and 22C are interconnect pattern layout diagrams for explaining still other steps of the flowchart of FIG. 16;

FIG. 23 is a flowchart for a pattern analysis method according to Embodiment 5 of the invention; and

FIGS. 24A, 24B, 24C, 24D, 24E and 24F are interconnect pattern layout diagrams for explaining respective steps of the flowchart of FIG. 23.

### DETAILED DESCRIPTION OF THE INVENTION

### EMBODIMENT 1

Now, a pattern analysis apparatus and a pattern analysis method according to Embodiment 1 of the invention will be described with reference to the accompanying drawings by exemplifying a case where a critical area of an interconnect pattern layout is calculated.

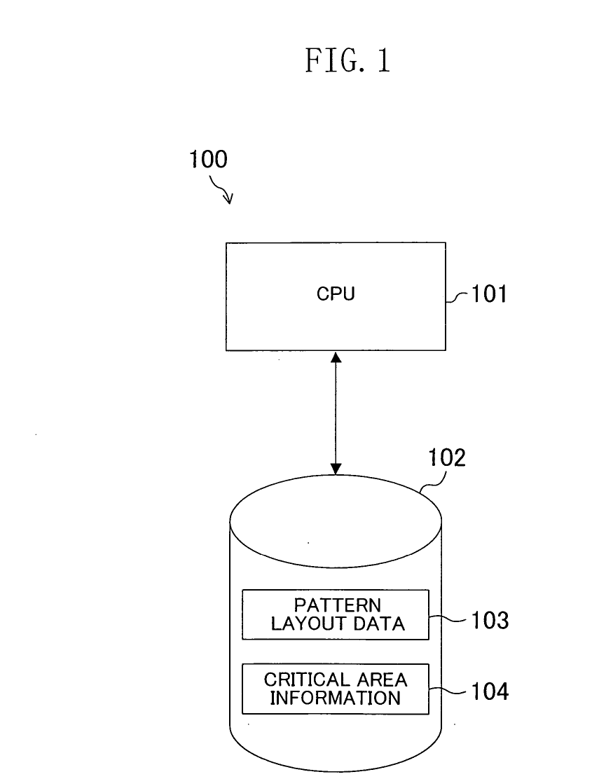

FIG. 1 is a diagram for showing an example of the architecture of the pattern analysis apparatus of Embodiment 1. As shown in FIG. 1, the pattern analysis apparatus 100 of this embodiment includes a central processing unit (CPU) 101 and a storage device 102 for storing pattern layout data 103 and critical area information 104. As operating means, the CPU 101 reads the pattern layout data 103 from the storage device 102 and executes the pattern analysis method of this embodiment described below by using the read pattern layout data 103. Also, as outputting means, the CPU 101 outputs, to the storage device 102, the critical area information 104 obtained as a result of the execution of the pattern analysis method of this embodiment.

Needless to say, the architecture of the pattern analysis apparatus used for executing the pattern analysis method of this embodiment described below is not limited to that shown in FIG. 1.

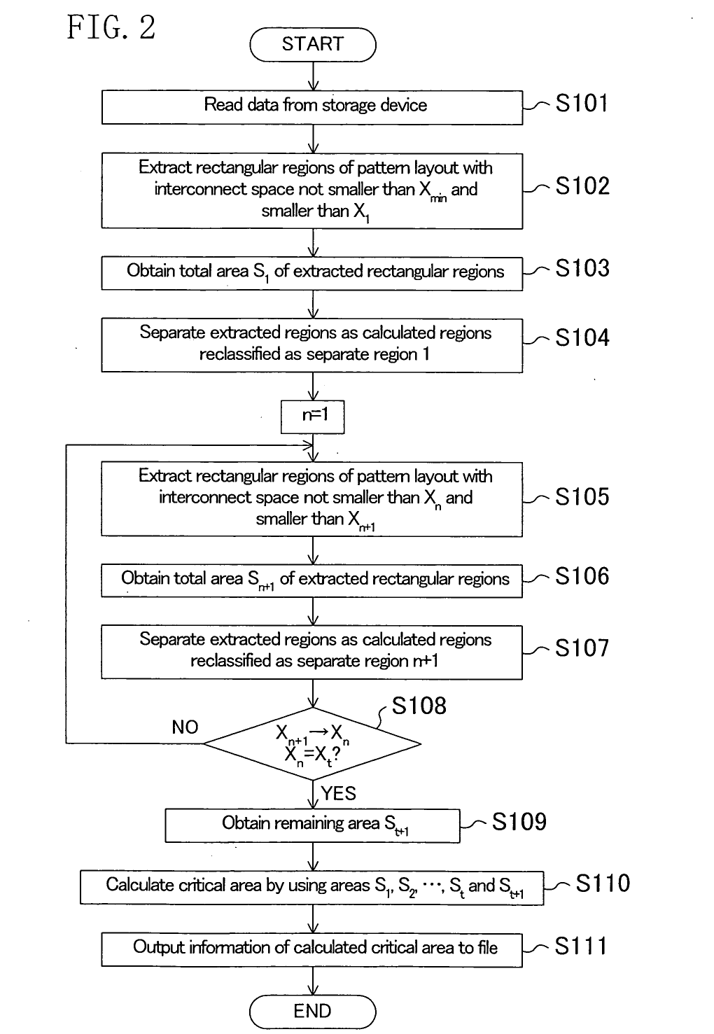

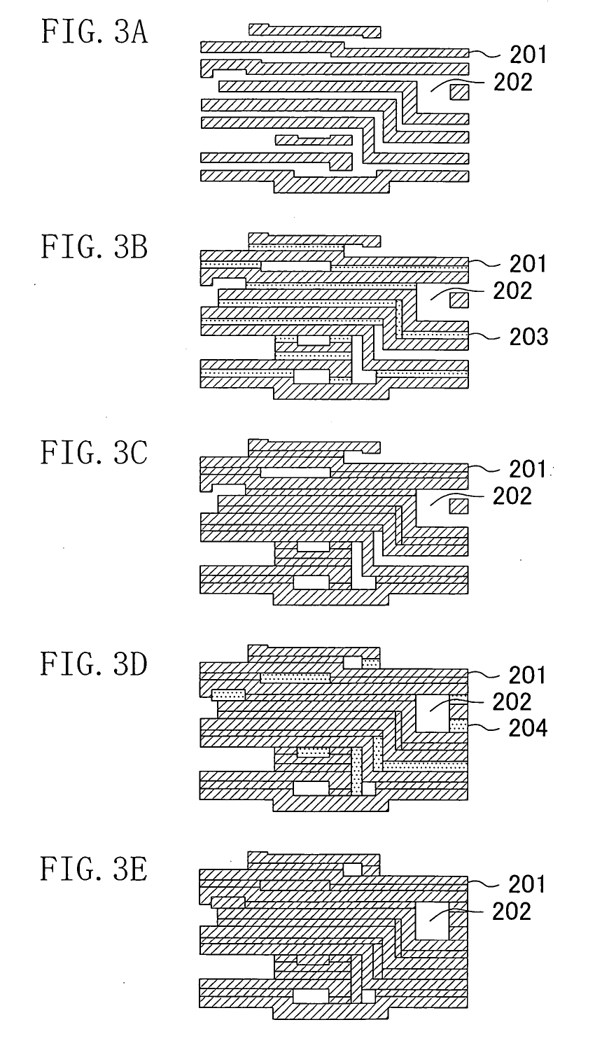

FIG. 2 is a flowchart for the pattern analysis method of Embodiment I using the pattern analysis apparatus of FIG. 1, and FIGS. 3A through 3E are interconnect pattern layout diagrams for explaining respective steps of the flowchart of FIG. 2.

First, in a first step S101, the pattern layout data 103, which is specifically mask data used as layout data of a specific interconnect pattern where a critical area is to be obtained, is read as CAD (computer aided design) data from the storage device 102 corresponding to a memory region of a computer. At this point, the interconnect pattern layout data includes, as shown in FIG. 3A, a plurality of line regions 201 corresponding to interconnects and a plurality of space regions 202 corresponding to regions between the interconnects. Also, in this embodiment, the plural space regions 202 are selected as a target region in which the critical area is to be calculated.

Next, in a second step S 102, from each of the space regions 202 corresponding to the target region, a plurality of first rectangular regions 203 each having a width (an interconnect space) not smaller than a minimum width (minimum space width) Xₘᵢₙ of the space region 202 and smaller than a width X₁ corresponding to a sum of the width Xₘᵢₙ and a pitch ΔX are extracted as shown in FIG. 3B (whereas the number of extracted first rectangular regions 203 may be one or no region may be extracted).

Next, in a third step S 103, a total area S₁ of the plural first rectangular regions 203 extracted in the second step S102 is obtained.

Then, in a fourth step S104, the first rectangular regions 203 extracted in the second step S102 are separated from the target region (the space regions 202) as a calculated region to be reclassified as a separate region 1. In other words, the first rectangular regions 203 extracted in the second step S102 are excluded from the target region. In this embodiment, the separate region 1 is dealt with as a line region 201 in the following steps as shown in FIG. 3C.

Next, procedures for extracting, from the target region, (n+1)th rectangular regions each having a width not smaller than a width Xₙ (wherein n is a natural number of 1 through t) and smaller than a width Xₙ₊₁ corresponding to a sum of the width Xₙ and the pitch ΔX, obtaining a total area Sₙ₊₁ of the (n+1)th rectangular regions, and excluding the (n+1)th rectangular regions from the target region are repeated while incrementing n by 1 until the width Xₙ becomes equal to a given value Xₜ (wherein t is an arbitrary natural number).

Specifically, after setting n to 1, in a fifth step S105, second rectangular regions 204 having a width (an interconnect space) not smaller than the width X₁ and smaller than a width X₂ corresponding to a sum of the width X₁ and the pitch ΔX are extracted from the remaining space regions 202 corresponding to the target region as shown in FIG. 3D (whereas the number of extracted second rectangular regions 204 may be one or no region may be extracted).

Next, in a sixth step S106, a total area S₂ of the second rectangular regions 204 extracted in the fifth step S105 is obtained.

Then, in a seventh step S107, the second rectangular regions 204 extracted in the fifth step S105 are separated from the target region (the remaining space regions 202) as a calculated region to be reclassified as a separate region 2. In other words, the second rectangular regions 204 extracted in the fifth step S105 are excluded from the target region. In this embodiment, the separate region 2 is dealt with as a line region 201 in the following steps as shown in FIG. 3E.

Subsequently, while incrementing n by 1 with keeping the pitch ΔX, until the space width Xₙ (wherein n is a natural number of 1 through t) is determined to be equal to the given number Xₜ (wherein t is an arbitrary natural number) in an eighth step S108, the procedures of the fifth step S105, the sixth step S106, the seventh step S107 and the eighth step S108 are repeatedly carried out. It is noted that a total area of tth rectangular regions obtained when the space width Xₙ is determined to be equal to the given value Xₜ in the eighth step S108 is herein assumed to be Sₜ.

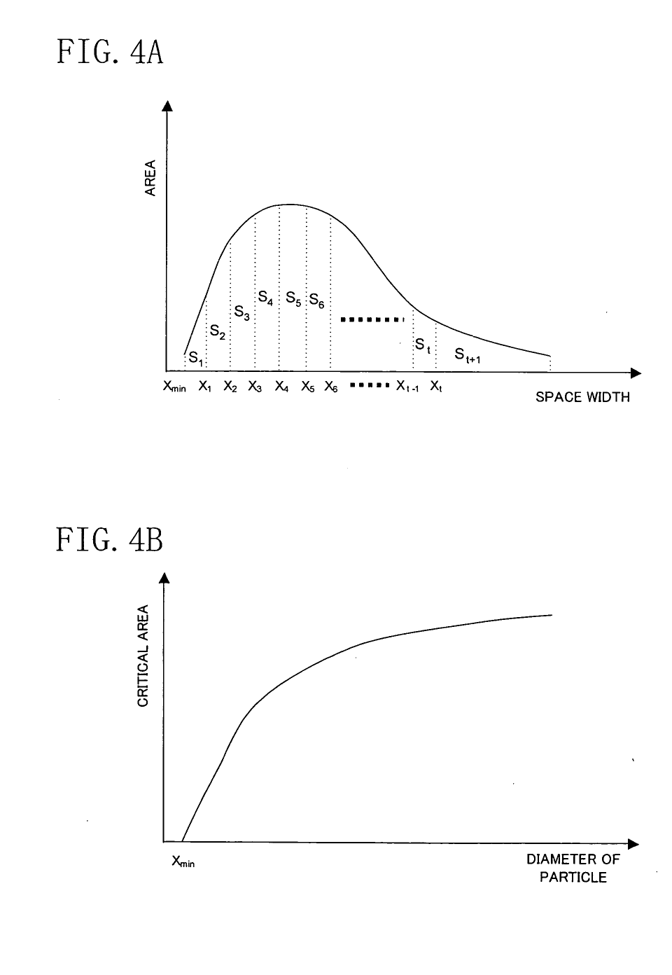

Next, after the space width Xₙ is determined to be equal to the given value Xₜ in the eighth step S108, a total area Sₜ₊₁ of the remaining target region (namely, the space regions 202 having a width not smaller than the given value Xₜ) is obtained in a ninth step S109. FIG. 4A shows a distribution, against the space widths Xₙ (specifically, the widths Xₘᵢₙ, X₁, X₂, . . . , Xₜ₋₁ and Xₜ), of the total areas S₁, S₂, . . . , Sₜ and Sₜ₊₁ obtained in the aforementioned manner.

Subsequently, in a tenth step S110, a critical area is calculated by using the total areas S₁, S₂, . . . Sₜ and Sₜ₊₁. A specific method for obtaining the critical area will be described later.

Then, in an eleventh step S111, information of the critical area calculated in the tenth step S110 (namely, the critical area information 104) is output to a file on the storage device 102, and thus, the pattern analysis processing is completed.

Now, an example of the critical area calculation method using the total areas S₁, S₂, . . . , Sₜ and Sₜ₊₁ performed in the tenth step S110 will be described in detail. It is noted that the critical area calculation method using the total areas S₁, S₂, . . . , Sₜ and Sₜ₊₁ is not limited to the following example.

In order to obtain a critical area of an actual product by using, for example, the aforementioned Formula 4-2 disclosed in Non-patent document 3, it is necessary to actually divide the product layout into rectangular patterns respectively having different interconnect widths w or different interconnect space widths s set at an appropriate pitch, and it is necessary to calculate the total length of the respective rectangular patterns (that is, a sum of the lengths of one long sides of respective rectangular patterns when they are in a rectangle shape and one sides thereof when they are in a square shape).

In accordance with recent development of EDA (electron design automation) technology, the width and the space of interconnects are automatically set to the same or substantially the same value in an actual product layout. Therefore, in this embodiment, on the assumption that the interconnect width and the interconnect space width have the same value (namely, w=s) in Formula 4-2, in the calculation of, for example, a critical area in consideration of short-circuit failure, merely a necessary length out of the total length of interconnect space regions (rectangular patterns) having a plurality of different space widths set at an appropriate pitch is accurately obtained so as to be used in Formula 4-2.

Specifically, the total interconnect length L of Formula 4-2 is calculated with respect to each of the total areas S₁, S₂, . . . , Sₜ and Sₜ₊₁ by using, for example, an approximate formula such as L₁=S₁/((X₁+Xₘᵢₙ)/2), L₂=S₂/((X₂+X₁)/2), . . . , Lₜ=Sₜ((Xₜ+Xₜ₋₁)/2) or Lₜ₊₁=Xₜ. Then, in the case where a failure-related particle has, for example, a diameter Xₙ, the total interconnect lengths L₁, L₂, . . . , Lₜ and Lₜ₊₁ are used to calculate a sum Acl(Xₙ) of Lₚ·(Xₙ−Xₚ) (see the second formula of Formula 4-2) of all the space widths Xₚ (wherein p is a natural number not larger than n) larger than Xₙ/3 and not larger than Xₙ. Also, a sum Ac2(Xₙ) of L_{q}·2X_{q} (see the third formula of Formula 4-2) of all the space widths X_{q} (wherein q is a natural number not larger than p) not larger than Xₙ/3 is calculated. Thus, the critical area can be calculated as a sum of the sums Acl(Xₙ) and Ac₂(Xₙ). FIG. 4B shows correlation between the critical area obtained in the aforementioned manner by using the total areas S₁, S₂, . . . , Sₜ and Sₜ₊₁ shown in FIG. 4A and the diameter of a particle. In FIG. 4B, the abscissa indicates the diameter of a particle and the ordinate indicates the critical area. When the critical area shown in FIG. 4B, namely, the critical area in consideration of short-circuit failure, is calculated, the yield in consideration of interconnect short-circuit can be calculated by assigning the thus obtained critical area in a known yield calculation formula (such as Formula 3 described in “Background of the Invention”).

In the above description, the critical area in consideration of short-circuit failure is calculated by carrying out the procedures of the first step S101 through the eleventh step S111 on the target region, namely, the plural space regions 202 corresponding to the regions between the interconnects. Similarly, when the plural line regions 201 corresponding to the interconnects are dealt with as the target region for carrying out the procedures of the first step S101 through the eleventh step S111, a critical area, namely, a yield, in consideration of interconnect open can be calculated.

According to Embodiment 1, the actual pattern layout data 103 including the plural line regions 201 and the plural space regions 202 can be dealt with as simple combinations of a plurality of rectangular patterns respectively having different widths (namely, the first rectangular regions 203, the second rectangular regions 204, etc.). In other words, in consideration of the relationship between the width of each rectangular pattern (more accurately, the width of the interconnect space) and the size of a defect such as a particle, the critical area can be easily and accurately calculated by using the total areas of the respective rectangular patterns. Accordingly, when the critical area thus obtained is used for calculating a yield, a highly precise yield very close to the yield of actual products can be rapidly calculated even with respect to complicated patterns of a highly integrated LSI.

The pattern analysis method of Embodiment 1 preferably further includes, between the first step S101 and the second step S102, a step of excluding, from the target region for calculating the critical area, a region where a dummy pattern (that is, a pattern having no function in the actual use of the product, such as a dummy interconnect pattern for improving the lithography accuracy) of the pattern layout data is disposed. Thus, the critical area can be precisely calculated with the dummy pattern not related to the yield of the actual products excluded, and therefore, a more highly precise yield close to the yield of the actual products can be calculated by using the critical area.

### EMBODIMENT 2

Now, a pattern analysis apparatus and a pattern analysis method according to Embodiment 2 of the invention will be described with reference to the accompanying drawings by exemplifying a case where a critical area of an interconnect pattern layout is calculated.

An example of the architecture of the pattern analysis apparatus of Embodiment 2 is the same as that of Embodiment 1 shown in FIG. 1. Specifically, as shown in FIG. 1, the pattern analysis apparatus 100 of this embodiment includes a central control unit (CPU) 101 and a storage device 102 for storing pattern layout data 103 and critical area information 104. As operating means, the CPU 101 reads the pattern layout data 103 from the storage device 102 and executes the pattern analysis method of this embodiment described below by using the read pattern layout data 103. Also, as outputting means, the CPU 101 outputs, to the storage device 102, the critical area information 104 obtained as a result of executing the pattern analysis method of this embodiment.

Needless to say, the architecture of the pattern analysis apparatus used for executing the pattern analysis method of this embodiment described below is not limited to that shown in FIG. 1.

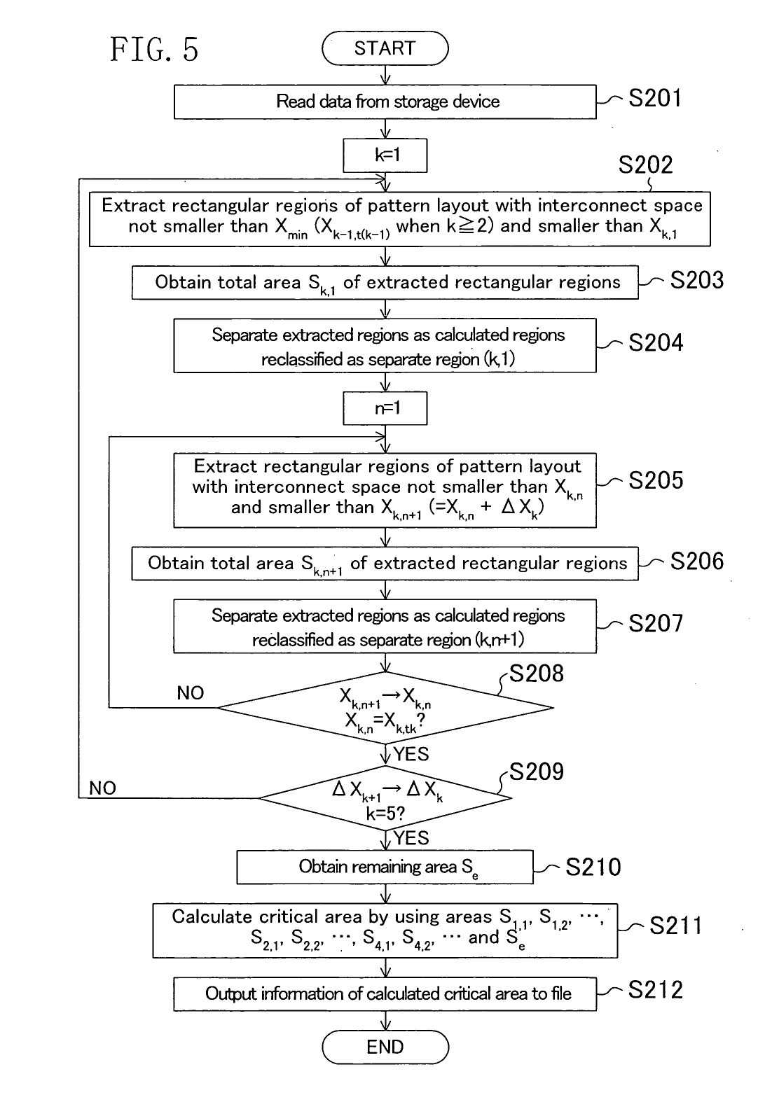

FIG. 5 is a flowchart for the pattern analysis method according to Embodiment 2 using the pattern analysis apparatus shown in FIG. 1.

First, in a first step S201, the pattern layout data 103, which is specifically mask data used as layout data of a specific interconnect pattern where a critical area is to be obtained, is read as CAD data from the storage device 102 corresponding to a memory region of a computer. At this point, the interconnect pattern layout data includes a plurality of line regions corresponding to interconnects and a plurality of space regions corresponding to regions between the interconnects. Also, in this embodiment, the plural space regions are selected as a target region in which the critical area is to be calculated. It is herein assumed that the minimum dimension (the minimum width) of the space regions corresponding to the target region is, for example, 0.1 μm.

Next, after setting k to 1, in a second step S202, from each of the space regions corresponding to the target region, rectangular regions (1,1) each having a width (an interconnect space width) not smaller than the minimum width (minimum space width) Xₘᵢₙ (of, for example, 0.1 μm) of the space regions and smaller than a width X_{1,1} (of, for example, 0.11 μm) corresponding to a sum of the width Xₘᵢₙ and a pitch ΔX₁ (of, for example, 0.01 μm) are extracted (whereas the number of extracted rectangular regions (1,1) may be one or no region may be extracted).

Next, in a third step S203, a total area S_{1,1} of the rectangular regions (1.1) extracted in the second step S202 is obtained.

Then, in a fourth step S204, the rectangular regions (1,1) extracted in the second step S202 are separated from the target region (the space regions) as a calculated region to be reclassified as a separate region (1,1). In other words, the rectangular regions (1,1) extracted in the second step S202 are excluded from the target region. In this embodiment, the separate region (1,1) is dealt with as a line region in the following steps.

Next, procedures for extracting, from the target region, rectangular regions (k,n+1) each having a width not smaller than a width X_{k,n} (wherein k and n are natural numbers) and smaller than a width X_{k,n+1} corresponding to a sum of the width X_{k,n} and a pitch ΔXₖ, obtaining a total area S_{k,n+1} of the rectangular regions (k,n+1), and excluding the rectangular regions (k,n+1) from the target region are repeatedly performed in a manner described below. At this point, in this embodiment, as the width Xₙ is larger, the pitch ΔX is increased, whereas the pitch ΔX is kept at a constant value as far as the width Xₙ falls within a given range.

Specifically, after setting n to 1 and k to 1, in a fifth step S205, rectangular regions (1,2) having a width (an interconnect space width) not smaller than the width X_{1,1} (of, for example, 0.11 μm) and smaller than a width X_{1,2} (of, for example, 0.12 μm) corresponding to a sum of the width X_{1,1} and the pitch ΔX₁ (of, for example, 0.01μ) are extracted from the remaining space regions corresponding to the target region (whereas the number of extracted rectangular regions (1,2) may be one or no region may be extracted).

Next, in a sixth step S206, a total area S_{1,2} of the rectangular regions (1,2) extracted in the fifth step S205 is obtained.

Then, in a seventh step S207, the rectangular regions (1,2) extracted in the fifth step S205 are separated from the target region (the remaining space regions) as a calculated region to be reclassified as a separate region (1,2). In other words, the rectangular regions (1,2) extracted in the fifth step S205 are excluded from the target region. In this embodiment, the separate region (1,2) is dealt with as a line region in the following steps.

Subsequently, while incrementing n by 1 up to a value t1 (corresponding to the maximum value of n when k is set to 1) with keeping the pitch ΔX₁ (of, for example, 0.01 μm) until a space width X_{1,n} (wherein n is a natural number) is determined to be equal to a given value X_{1,t1} (of, for example, 0.2 μm) in an eighth step S208, the procedures of the fifth step S205, the sixth step S206, the seventh step S207 and the eighth step S208 are repeatedly carried out.

Next, when the space width X_{1,n} is determined to be equal to the given value X_{1,t1} (of, for example, 0.2 μm) in the eighth step S208, the pitch is set to ΔX₂ (of, for example, 0.02 μm) in a ninth step S209. In other words, the value k is incremented by 1 to be set to 2.

Thereafter, in the second step S202, from the remaining space regions corresponding to the target region, rectangular regions (2,1) each having a width (an interconnect space width) not smaller than the width X_{1,t1} (of, for example, 0.2 μm) corresponding to the maximum value of the width X_{1,n} and smaller than a width X_{2,1} (of, for example, 0.22 μm) corresponding to a sum of the width X_{1,t1} and the pitch ΔX₂ (of, for example, 0.02 μm) are extracted (whereas the number of extracted rectangular regions (2,1) may be one or no region may be extracted).

Next, in the third step S203, a total area S_{2,1} of the rectangular regions (2,1) extracted in the second step S202 is obtained.

Then, in the fourth step S204, the rectangular regions (2,1) extracted in the third step S203 are separated from the target region (the space regions) as a calculated region to be reclassified as a separate region (2,1). In other words, the rectangular regions (2,1) extracted in the third step S203 are excluded from the target region. In this embodiment, the separate region (2,1) is dealt with as a line region in the following steps.

Next, after setting n to 1, the procedures of the fifth step S205, the sixth step S206, the seventh step S207 and the eighth step S208 are repeatedly carried out while keeping the pitch ΔX₂ (of, for example, 0.02 μm) and incrementing n by 1 up to a value t2 (that is, the maximum value of n when k is set to 2) until the space width X_{2,n} (wherein n is a natural number) is determined to be equal to a given value X_{2,t2} (of, for example, 0.5 μm) in the eighth step S208.

Next, when the space width X_{2,n} is determined to be equal to the given value X_{2,t2} (of, for example, 0.5 μm) in the eighth step S208, the pitch is set to ΔX₃ (of, for example, 0.1 μm) in the ninth step S209. In other words, the value k is incremented by 1 to be set to 3.

Thereafter, the procedures of the second step S202, the third step S203, the fourth step S204, the fifth step S205, the sixth step S206, the seventh step S207, the eighth step S208 and the ninth step S209 are similarly repeatedly carried out until k is set to 4 (because the maximum value of k is set to 4 in this embodiment), namely, until these procedures are performed by using space widths X_{3,n} and X_{4,n}.

When it is determined in the eighth step S208 that the space width X_{3,n} is equal to a given value X_{3,t3} (of, for example, 1 sum, wherein t3 is the maximum value of n when k is set to 3), the pitch is set to ΔX₄ (of, for example, 1 μm) in the ninth step S209.

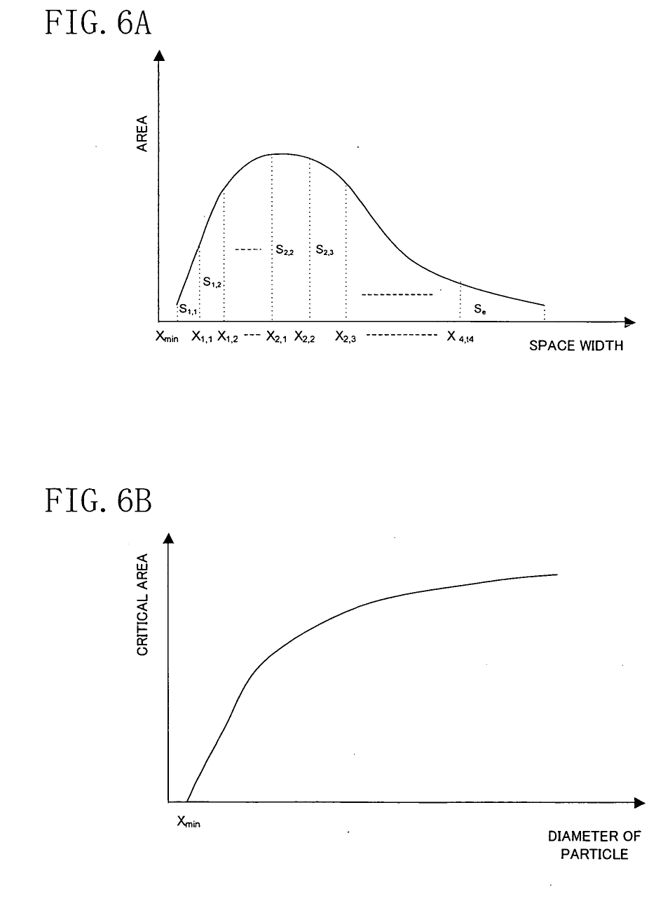

Also, in the case where it is determined in the eighth step S208 that the space width X_{4,n} is equal to a given value X_{4,t4} (of, for example, 10 μm, whereas t4 is the maximum value of n when k is set to 4) and it is determined in the following ninth step S209 that k is 5, a total area Sₑ of the remaining target region (namely, space regions having a width not less than the given value X_{4,t4} (of, for example, 10 μm)) is obtained in a tenth step S210. FIG. 6A shows a distribution of the thus obtained total areas S_{1,1}, S_{1,2}, S_{1,3}, . . . , S_{1,t1}, S_{2,1}, S_{2,2}, S_{2,3}, . . . , S_{2,t2}, S_{3,1}, S_{3,2}, S_{3,3}, . . . , S_{3,t3}, S_{4,1}, S_{4,2}, S_{4,3}, . . . ,S_{4,t4} and Sₑ against the space widths X_{k,n} (specifically, space width Xₘᵢₙ, X_{1,1}, X_{1,2}, . . . , X_{2,1}, X_{2,2}, . . . and X_{4,t4}).

Next, in an eleventh step S211, the critical area is calculated by using the total areas S_{1,1}, S_{1,2}, . . . , S_{2,1}, S_{2,2}, . . . and S_{e.} Specifically, the critical area can be calculated, for example, in the same manner as in the tenth step S110 of Embodiment 1. FIG. 6B shows correlation between the critical area obtained in the same manner as in Embodiment 1 by using the total areas S_{1,1}, S_{1,2}, . . . , S_{2,1}, S_{2,2}, . . . and Sₑ shown in FIG. 6A and the diameter of a particle. In FIG. 6B, the abscissa indicates the diameter of a particle and the ordinate indicates the critical area. When the critical area shown in FIG. 6B, namely, the critical area in consideration of short-circuit failure, is calculated, a yield in consideration of interconnect short-circuit can be calculated by assigning the critical area in a known yield calculation formula (such as Formula 3 described in “Background of the Invention”).

Next, in a twelfth step S212, information of the critical area calculated in the eleventh step S211 (namely, the critical area information 104) is output to a file on the storage device 102. Thus, the pattern analysis processing is completed.

In the above description, the critical area in consideration of short-circuit failure is calculated by performing the procedures of the first step S201 through the twelfth step S212 on the target region, namely, the plural space regions corresponding to the regions between interconnects. Similarly, when the plural line regions corresponding to the interconnects are dealt with as the target region for performing the procedures of the first step S201 through the twelfth step S212, a critical area in consideration of interconnect open, namely, a yield in consideration of the interconnect open, can be calculated.

According to Embodiment 2, the same effects as those of Embodiment 1 can be attained. Specifically, the actual pattern layout data 103 including a plurality of line regions and a plurality of space regions can be dealt with as simple combinations of a plurality of rectangular patterns having different widths (such as the rectangular regions (1,1), the rectangular regions (1,2), etc.). In other words, in consideration of the relationship between the width of each rectangular pattern (more precisely, the width of the interconnect space) and the size of a defect such as a particle, a critical area can be easily and accurately calculated by using the total areas of the respective rectangular patterns. Accordingly, when the critical area thus obtained is used in the calculation of a yield, a highly precise yield very close to the yield of actual products can be rapidly calculated even with respect to complicated patterns of a highly integrated LSI.

Furthermore, according to Embodiment 2, since the pitch ΔXₖ is increased as the space width X_{k,n} is larger, the calculation speed can be increased without degrading the calculation accuracy in the calculation of the critical area. Also, at this point, since the pitch ΔXₖ is kept at a constant value as far as the space width X_{k,n} falls within a given range, the calculation speed can be further increased. Specifically, in the case where the width X_{k,n} is smaller than a value (substantially) twice as large as the minimum width Xₘᵢₙ as in this embodiment, the pitch ΔXₖ is set to a value (substantially) 1/10 as large as the minimum width Xₘᵢₙ. In the case where the width X_{k,n} is not smaller than the value (substantially) twice as large as the minimum width Xₘᵢₙ and smaller than a value (substantially) five times as large as the minimum width Xₘᵢₙ, the pitch ΔXₖ is set to a value (substantially) ⅕ as large as the minimum width Xₘᵢₙ. In the case where the width X_{k,n} is not smaller than the value (substantially) five times as larger as the minimum width Xₘᵢₙ and smaller than a value (substantially) ten times as large as the minimum width Xₘᵢₙ, the pitch ΔXₖ is set to a value (substantially) equivalent to the minimum width Xₘᵢₙ. In the case where the width X_{k,n} is not smaller than the value (substantially) ten times as large as the minimum width Xₘᵢₙ and smaller than a value (substantially) a hundred times as large as the minimum width Xₘᵢₙ, the pitch ΔXₖ is set to a value (substantially) ten times as large as the minimum width Xₘᵢₙ.

In Embodiment 2, in order to, for example, further increase the calculation speed for the critical area, a value different from that used in the above description can be used as each pitch ΔXₖ (wherein k is a natural number). Also, the maximum value of the value k may be different from that used in the above description. The respective given values X_{1,t1}, X_{2,t2}, X_{3,t3} and X_{4,t4} are expressed by using the value k as X_{k,tk} (wherein tk is a natural number), and different values from those used in the above description may be used as the values X_{k,tk} and a different value from that used in the above description may be used as the value tk (namely, the maximum value of the value n corresponding to each value of k). Furthermore, different values may be set as the pitches ΔXₖ, the given values X_{k,tk}, the maximum values of the value k and the value tk between the calculation for a critical area with the space regions regarded as the target region and the calculation for a critical area with the line regions regarded as the target region.

Furthermore, in the case where a critical area is actually calculated in accordance with Embodiment 2, since the original data of the line regions is generally a set of rectangles, the calculation accuracy tends to be improved by reducing the pitch ΔXₖ (wherein k is a natural number). In contrast, since the original data, namely, original shapes, of the space regions are complicated, time necessary for the calculation is increased when the pitch ΔXₖ (wherein k is a natural number) is set to a too small value. Therefore, the pitch ΔXₖ should be determined in consideration of these conditions.

Moreover, the pattern analysis method of Embodiment 2 preferably further includes, between the first step S201 and the second step S202, a step of excluding, from the target region for calculating the critical area, a region where a dummy pattern of the pattern layout data is disposed. Thus, the critical area can be precisely calculated with the dummy pattern not related to the yield of the actual product excluded, and therefore, a more highly precise yield close to the yield of actual products can be calculated by using the critical area.

### EMBODIMENT 3

Now, a pattern analysis apparatus and a pattern analysis method according to Embodiment 3 of the invention will be described with reference to the accompanying drawings by exemplifying a case of calculating the number of single connection vias working as contacts for electrically connecting a lower interconnect and an upper interconnect in a multilayer interconnect structure of an LSI. It is noted that a yield YRV depending upon contact failure can be obtained by assigning the number of single connection vias obtained in this embodiment in, for example, Formula 6 (described in “Background of the Invention”) as the number N of vias.

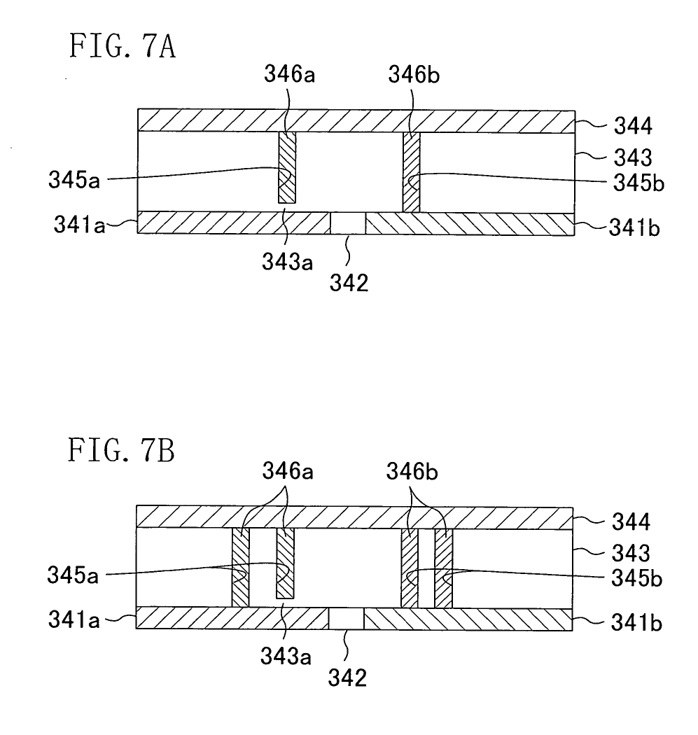

First, a “single connection via” and “contact failure” will be described. FIGS. 7A and 7B are diagrams for explaining the “single connection via” and the “contact failure” in the cross-sectional structure of a part (multilayered interconnects) of a device. FIG. 7A shows electric connection between a lower interconnect and an upper interconnect through a single connection via and FIG. 7B shows electric connection between a lower interconnect and an upper interconnect through a plurality of vias.

As shown in FIGS. 7A and 7B, an interlayer insulating film 343 is provided on a first lower interconnect 341a and a second lower interconnect 341b isolated from each other by an insulating film 342, and an upper interconnect 344 is provided on the interlayer insulating film 343. Also, a first via hole 345a is formed in the interlayer insulating film 343 for electrically connecting the first lower interconnect 341a and the upper interconnect 344 to each other, and a first contact plug 346a is filled in the first via hole 345a. Furthermore, a second via hole 345b is formed in the interlayer insulating film 343 for electrically connecting the second lower interconnect 341b and the upper interconnect 344 to each other, and a second contact plug 346b is filled in the second via hole 345b.

As shown in FIG. 7A, in the case where merely one via is provided for connecting the lower interconnect and the upper interconnect to each other, if an insulating film portion 343a remains below, for example, the first via hole 345a, there arises contact failure that the first lower interconnect 341a is disconnected from the upper interconnect 344.

However, when such failure is derived from, for example, a particle and a plurality of (more specifically, two in this case) vias are provided for connecting the lower interconnect and the upper interconnect to each other as shown in FIG. 7B, a probability that the contact failure occurs in both the two vias is much lower than a probability that the contact failure occurs in one via alone and hence is negligible. Therefore, even when the insulating film portion 343a remains below, for example, one of the first via holes 345a, the electric connection between the first lower interconnect 341a and the upper interconnect 344 can be kept. On the other hand, even in the case where a plurality of vias are provided for connecting the lower interconnect and the upper interconnect to each other, if there is a problem in conditions for forming the vias (such as etching conditions for forming via holes), the probability that the contact failure occurs in all the vias for connecting the lower interconnect and the upper interconnect to each other is high.

Accordingly, when the yield YRV depending upon contact failure is obtained by using, for example, Formula 6 (described in “Background of the Invention”), it is necessary to calculate the yield separately with respect to failure depending upon the number of vias and failure not depending upon the number of vias. In addition, it is necessary to calculate the yield separately in the cases shown in FIGS. 7A and 7B, namely, in the case where the number of vias for connecting the lower interconnect and the upper interconnect to each other is one (which via is hereinafter referred to as the single connection via) and in the case where the number of vias is two or more. In the pattern analysis apparatus and the pattern analysis method of this embodiment, a total number of single connection vias used in, for example, the multilayer interconnect structure of an LSI is obtained on the basis of the aforementioned technical idea.

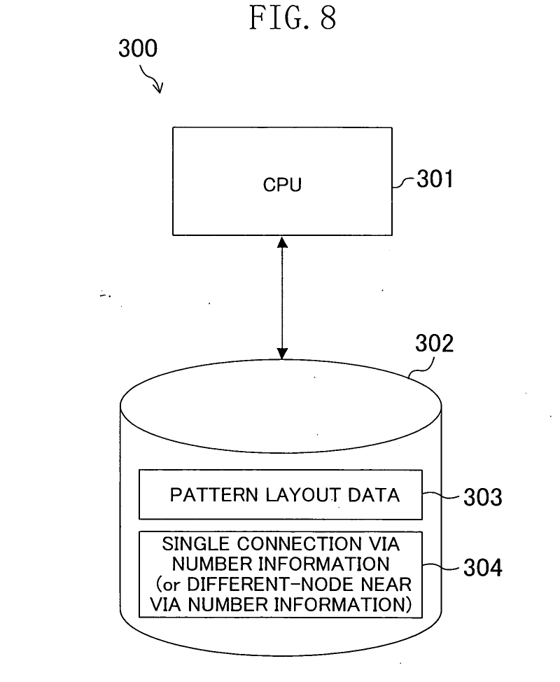

FIG. 8 is a diagram for showing an example of the architecture of the pattern analysis apparatus of Embodiment 2. As shown in FIG. 8, the pattern analysis apparatus 300 of this embodiment includes a central control unit (CPU) 301 and a storage device 302 for storing pattern layout data 303 and single connection via number information 304. As operating means, the CPU 301 reads the pattern layout data 303 from the storage device 302 and executes the pattern analysis method of this embodiment described below by using the read pattern layout data 303. Also, as outputting means, the CPU 301 outputs, to the storage device 302, the single connection via number information 304 obtained as a result of executing the pattern analysis method of this embodiment.

Needless to say, the architecture of the pattern analysis apparatus used for executing the pattern analysis method of this embodiment described below is not limited to that shown in FIG. 8.

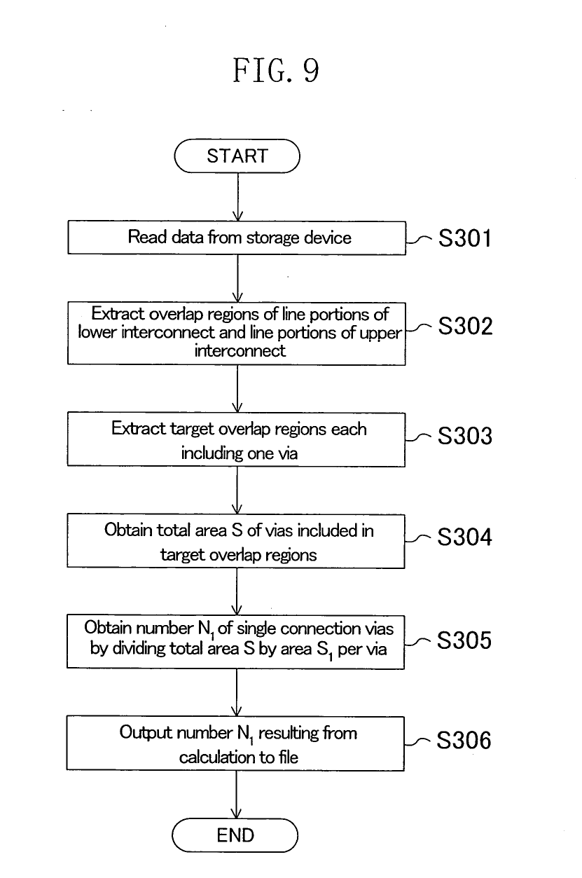

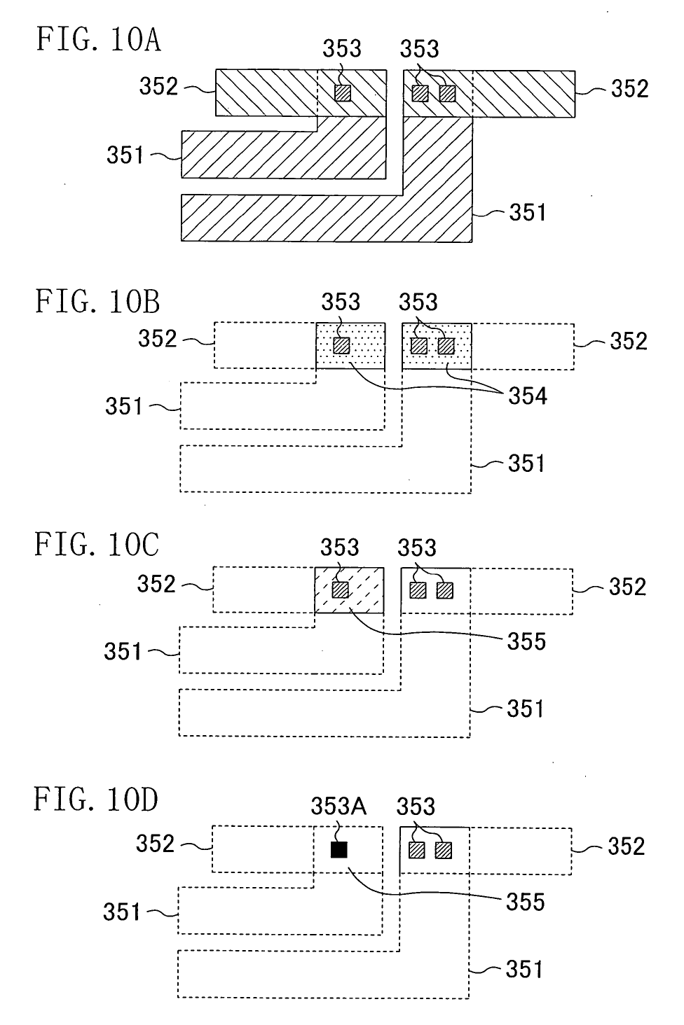

FIG. 9 is a flowchart for the pattern analysis method according to Embodiment 3 using the pattern analysis apparatus shown in FIG. 8, and FIGS. 10A through 10D are interconnect pattern layout diagrams for explaining respective steps of the flowchart shown in FIG. 9.

First, in a first step S301, the pattern layout data 303, which is specifically mask data used as layout data of a specific pattern, is read as CAD data from the storage device 302 corresponding to a memory region of a computer. The pattern layout data read at this point includes pattern layout data of a lower interconnect and an upper interconnect included in a multilayer interconnect structure (namely, interconnect pattern layout data) and pattern layout data of vias for connecting the lower interconnect and the upper interconnect to each other (namely, contact pattern layout data). The interconnect pattern layout data includes a plurality of line regions corresponding to interconnects and a plurality of space regions corresponding to regions between the interconnects. FIG. 10A shows the interconnect pattern layout data of the upper and lower interconnects and the contact pattern layout data overlapped. Specifically, as shown in FIG. 10A, a plurality of line portions 351 of the lower interconnect of the lower interconnect pattern layout data and a plurality of line portions 352 of the upper interconnect of the upper interconnect pattern layout data are electrically connected to each other through a plurality of vias 353 of the contact pattern layout data.

Next, in a second step S302, overlap regions 354 where the line portions 351 of the lower interconnect and the line portions 352 of the upper interconnect are overlapped are extracted as shown in FIG. 10B.

Then, in a third step S303, target overlap regions 355 each including merely one via 353 are extracted from all the overlap regions 354 extracted in the second step S302 as shown in FIG. 10C.

Next, in a fourth step S304, a total area S of all vias 353A included in all the target overlap regions 355 extracted in the third step S303 is obtained as shown in FIG. 10D.

Then, in a fifth step S305, the total area S is divided by an area S₁ per via 353 so as to obtain the number N₁ of single connection vias. At this point, the area S₁ per via 353 means a contact area between a via 353 and an interconnect connected to the via (namely, a line portion 351 of the lower interconnect or a line portion 352 of the upper interconnect) on the layout data.

Then, in a sixth step S306, the result of the calculation performed in the fifth step S305, namely, information of the number N₁ of single connection vias (i.e., the signal connection via number information 304) is output to a file on the storage device 302, and thus, the pattern analysis processing is completed.

On the basis of the number N₁ of single connection vias obtained in the aforementioned manner and, for example, via fraction defective determined by the process (obtained by using, for example, a test pattern), a yield depending upon via failure can be accurately calculated by using, for example, Formula 6.

In Embodiment 3, after extracting the overlap regions 354 where the line portions 351 of the lower interconnect and the line portions 352 of the upper interconnect are overlapped, the target overlap regions 355 each including merely one via 353 are extracted from the extracted overlap regions 354. Thereafter, the total area S of the vias 353A included in all the extracted target overlap regions 355 is obtained, and the total area S is divided by the area S₁ per via, so as to obtain the number N₁ of single connection vias. Therefore, the number N₁ of single connection vias can be efficiently and accurately calculated. Accordingly, when the number N₁ of single connection vias thus obtained is used in the yield calculation together with, for example, the via fraction defective determined by the process, a highly precise yield very close to the yield of actual products can be rapidly calculated even with respect to complicated patterns of a highly integrated LSI.

Although the multilayered interconnect pattern used in the above description includes two layers of interconnects, also with respect to a multilayered interconnect pattern including three or more layers of interconnects, the number of single connection vias necessary for the yield calculation can be obtained by repeating similar procedures.

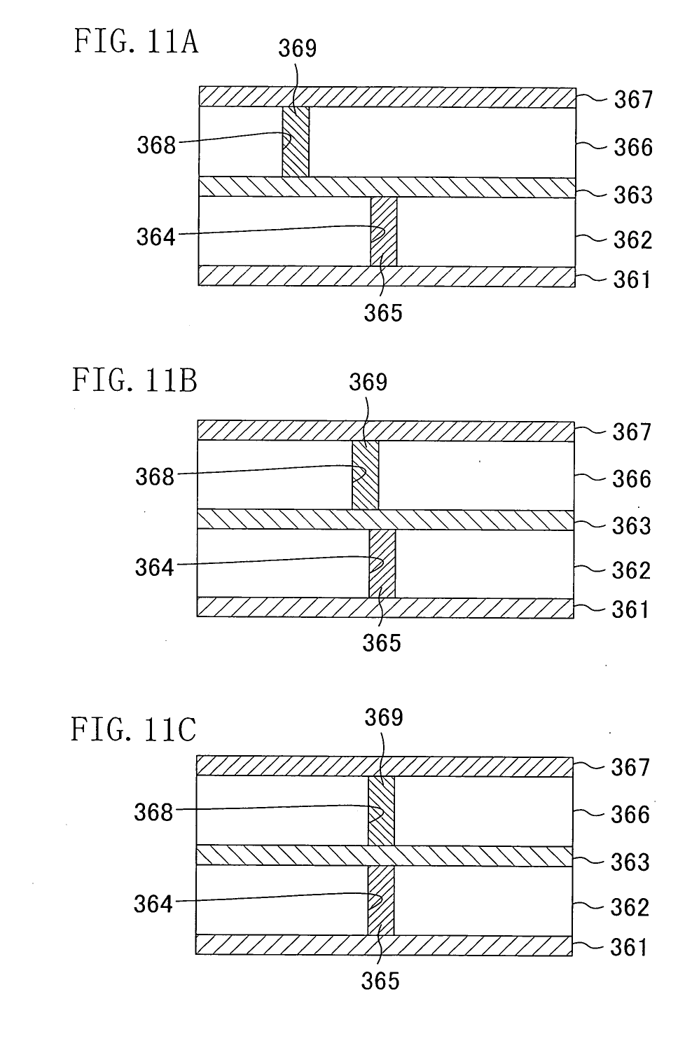

In this case, however, even when a yield of contacts between a first layered interconnect and a second layered interconnect and a yield of contacts between the second layered interconnect and a third layered interconnect are simply integrated, a value close to the yield of actual products cannot be obtained in many cases. The reason will be described with reference to FIGS. 11A through 11C. FIGS. 11A through 11C shows the schematic cross-sectional structure of a part (a three-layered interconnect structure part) of a device.

As shown in FIGS. 11A through 11C, a first interlayer insulating film 362 is provided on a first layered interconnect 361, and a second layered interconnect 363 is provided on the first interlayer insulating film 362. The first layered interconnect 361 and the second layered interconnect 363 are electrically connected to each other through a first contact plug 365 filled in a first via hole 364 formed in the first interlayer insulating film 362. Also, a second interlayer insulating film 366 is provided on the second layered interconnect 363, and a third layered interconnect 367 is provided on the second interlayer insulating film 366. The second layered interconnect 363 and the third layered interconnect 367 are electrically connected to each other through a second contact plug 369 filled in a second via hole 368 formed in the second insulating film 366.

FIG. 11A shows a structure in which the first via hole 364 and the second via hole 368 have no overlap portion (in a plan view, which also applies to the following description). FIG. 11B shows a structure in which the first via hole 364 and the second via hole 368 have an overlap portion with a size substantially corresponding to a half of the via hole diameter. FIG. 11C shows a structure in which the first via hole 364 and the second via hole 368 have an overlap portion with a size substantially equal to the via hole diameter. In other words, in the structure shown in FIG. 11C, the first via hole 364 and the second via hole 368 are substantially completely overlapped.

In the structure shown in FIG. 11A, in the calculation of the yield depending upon the via failure, the first via hole 364 (namely, the first contact plug 365) and the second via hole 368 (namely, the second contact plug 369) can be independently dealt with. In other words, in the calculation of the yield of the product, the yield of the contact between the first layered interconnect 361 and the second layered interconnect 362 and the yield of the contact between the second layered interconnect 363 and the third layered interconnect 367 are simply integrated.

However, in the structure shown in FIG. 11B or FIG. 11C, for example, formation of the second via hole 368 is affected by the first via hole 364, and hence, a failure mode obtained in this case is different from that obtained in the formation of the second via hole 368 in the structure of FIG. 11A.

An actual interconnect pattern mixedly includes the structures of FIGS. 11A, 11B and 11C, and therefore, in order to obtain an accurate yield, it is necessary to calculate the yields separately with respect to the structure of FIG. 11A, the structure of FIG. 11B and the structure of FIG 11C.

Next, as a modification of this embodiment, a method for obtaining the number of single connection vias necessary for the yield calculation in consideration of the aforementioned overlap states of vias in the multilayer interconnect structure will be described.

First, in the fourth step S304 of the flowchart of this embodiment shown in FIG. 9, the overlap states between lower vias (such as the first via hole 364 or the first contact plug 365) and upper vias (such as the second via hole 368 or the second contact plug 369) included in the multilayer interconnect structure are classified into N (wherein N is a natural number) kinds of states, and N kinds of total areas S are obtained with respect to the N kinds of states. Specifically, the overlap states are classified into a state A where the lower via and the upper via are not overlapped (corresponding to FIG. 11A; and including a state where the overlap portion between the lower via and the upper via is smaller than the alignment margin), a state B where the overlap portion between the lower via and the upper via is not smaller than the alignment margin and smaller than a half of the via diameter (corresponding to FIG. 11B), and a state C where the overlap portion between the lower via and the upper via is not smaller than a half of the via diameter and smaller than the via diameter (corresponding to FIG. 11C), and total areas (the total areas of vias included in the target overlap region extracted in the third step S303) S_{A}, S_{B} and S_{C} are calculated with respect to the states A through C.

Next, in the fifth step S305, the total areas S_{A}, S_{B} and S_{C} are respectively divided by the area S₁ per via, so as to obtain the single connection via numbers N_{1A}, N_{1B} and N_{1C} with respect to the states A through C. The thus obtained single connection via numbers N_{1A}, N_{1B} and N_{1C} are respectively integrated with via fraction defective of the states A through C (obtained by, for example, using a test pattern), and the results are assigned in, for example, Formula 6 (described in “Background of the Invention”) so as to obtain yields attained in the states A through C. When these yields are integrated with one another, a more precise yield of the product can be calculated.

The pattern analysis method of Embodiment 3 preferably further includes, between the first step S301 and the fourth step S304, a step of excluding a region where a dummy pattern is disposed from the respective pattern layout data (that is, the interconnect pattern layout data of the upper and lower interconnects and the contact pattern layout data), the overlap region 354 or the target overlap region 355. Thus, the number of single connection vias can be precisely calculated with the dummy pattern not related to the yield of the actual product excluded, and therefore, a more highly precise yield close to the yield of the actual products can be calculated by using the number of single connection vias.

In Embodiment 3, the number of single connection vias for electrically connecting a lower interconnect and an upper interconnect to each other in a multilayer interconnect structure of an LSI is calculated. However, it goes without saying that the present invention is applicable to calculation of the number of single connection vias for electrically connecting, for example, a diffusion layer of a transistor or the like to an upper interconnect disposed above or a lower interconnect to an electrode or the like of a capacitative element disposed above.

### EMBODIMENT 4

Now, a pattern analysis apparatus and a pattern analysis method according to Embodiment 4 of the invention will be described with reference to the accompanying drawings by exemplifying a case where a critical area of an interconnect pattern layout is calculated.

An example of the architecture of the pattern analysis apparatus of Embodiment 4 is the same as that of Embodiment 1 shown in FIG. 1. Specifically, as shown in FIG. 1, the pattern analysis apparatus 100 of this embodiment includes a central processing unit (CPU) 101 and a storage device 102 for storing pattern layout data 103 and critical area information 104. As operating means, the CPU 101 reads the pattern layout data 103 from the storage device 102 and executes the pattern analysis method of this embodiment described below by using the read pattern layout data 103. Also, as outputting means, the CPU 101 outputs, to the storage device 102, the critical area information 104 obtained as a result of the execution of the pattern analysis method of this embodiment.

Needless to say, the architecture of the pattern analysis apparatus used for executing the pattern analysis method of this embodiment described below is not limited to that shown in FIG. 1.

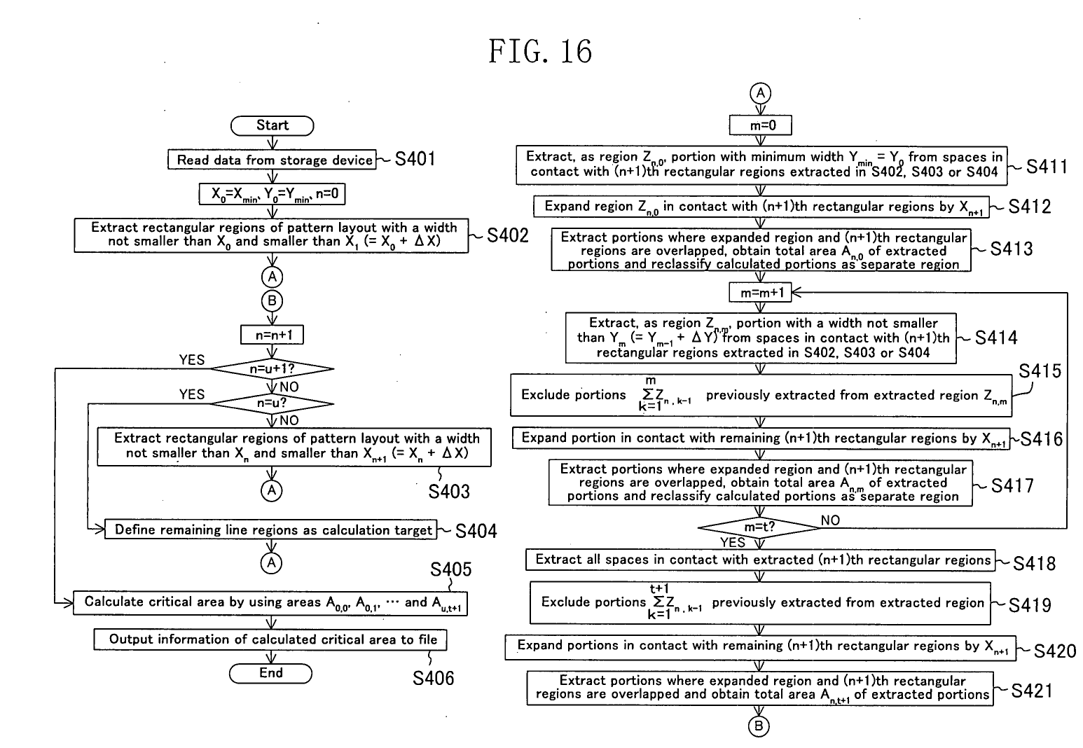

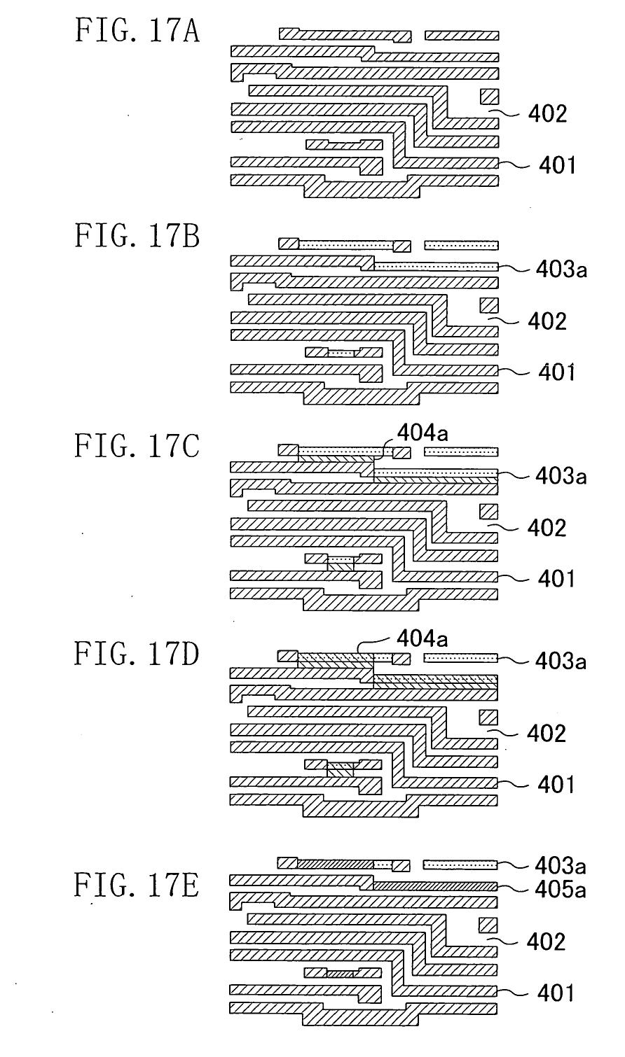

FIG. 16 is a flowchart for the pattern analysis method of Embodiment 4 using the pattern analysis apparatus of FIG. 1, and FIGS. 17A through 17E, 18A through 18E, 19A through 19E, 20A through 20D, 21A through 21D and 22A through 22C are interconnect pattern layout diagrams for explaining respective steps of the flowchart of FIG. 16.

First, in a first step S401, the pattern layout data 103, which is specifically mask data used as layout data of a specific interconnect pattern where a critical area is to be obtained, is read as CAD (computer aided design) data from the storage device 102 corresponding to a memory region of a computer. At this point, the interconnect pattern layout data includes, as shown in FIG. 17A, a plurality of line regions 401 corresponding to interconnects and a plurality of space regions 402 corresponding to regions between the interconnects. Also, in this embodiment, the plural line regions 401 are selected as a target region in which the critical area is to be calculated, and the space regions 402 not selected are defined as a non-target region. At this point, the minimum dimension X₀ of the line regions 401 is set to Xₘᵢₙ, the minimum dimension Y₀ of the space regions 402 is set as to Yₘᵢₙ, and the initial value of n (which is 0 or a natural number) is set to 0.

Next, in a step S402, as shown in FIG. 17B, a plurality of first rectangular regions 403a having a width (interconnect line width) not smaller than the minimum width (the minimum line width) Xₘᵢₙ of the line region 401 and smaller than a width Xₙ₊₁ (which is X₁ when n=0) corresponding to a sum of the width Xₘᵢₙ and a pitch ΔX are extracted from each of the line regions 401 corresponding to the target region (whereas the number of extracted first rectangular regions 403a may be one or no region may be extracted).

At this point, the initial value of m (which is 0 or a natural number) is set to 0.

Then, in a step S411, as shown in FIG. 17C, a region 404a having the minimum space width Yₘᵢₙ=Y₀ (namely, a first adjacent region Z_{0,0}) is extracted from a portion of the space regions 402 in contact with each first rectangular region 403a extracted in the step S402. The first adjacent region Z_{0,0} corresponds to a region sandwiched between the line regions 401.

Next, in a step S412, as shown in FIG. 17D, the width of the region 404a (the first adjacent region Z_{0,0}) extracted in the step S411 is increased by a width Xₙ₊₁ in a direction toward the adjacent first rectangular region 403a. At this point, in the case where merely one side of the first adjacent region Z_{0,0} is in contact with the first rectangular region 403a, the width is increased on that side alone by the width Xₙ₊₁, and in the case where both the sides of the first adjacent region Z_{0,0} are in contact with the first rectangular regions 403a, the width is increased on the both sides each by the width Xₙ₊₁.

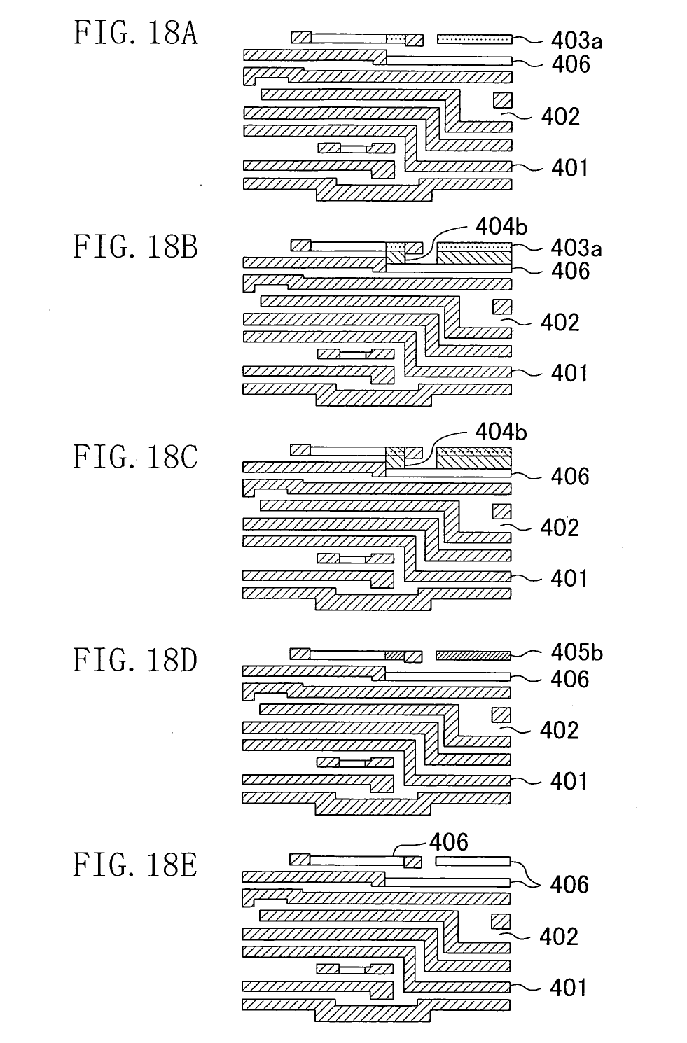

Then, in a step S413, as shown in FIG. 17E, portions 405a where the regions 404a increased in the step S412 and the first rectangular regions 403a extracted in the step S402 are overlapped are extracted, and a total area A_{n,m} of the extracted portions 405a (specifically, when n=0 and m=0, a total area A_{0,0} of rectangular regions having a width not smaller than the width Xₘᵢₙ and smaller than the width X₁ and adjacent to a space region 402 with the minimum width Yₘᵢₙ) is obtained. Thereafter, as shown in FIG. 18A, the portions 405a extracted in the step S413 are reclassified as a calculated region 406. In other words, the extracted portions 405a are excluded from the first rectangular regions 403a.

Next, after setting m to m+1, in step S414, a region 404b (that is, a (n,m)th adjacent region Z_{n,m}) having a space width not larger than the width Yₘ (wherein Yₘ=Yₘ₋₁+ΔY (wherein ΔY is a pitch)) is extracted from a portion of the space regions 402 in contact with the remaining first rectangular regions 403a as shown in FIG. 18B. In the case where the portions already used for calculating the total area A_{n,m} have not been separated from the first rectangular regions 403a to be reclassified as the calculated region 406 at this point, in a step S415, a sum of already extracted adjacent regions Z_{n,0}, Z_{n,1}, . . . and Z_{n,m-1} may be excluded from the adjacent region Z_{n,m} extracted in the step S414, so as to define a remaining region as the region 404b shown in FIG. 18B.

Then, in a step S416, as shown in FIG. 18C, the width of the region 404b is increased by the width Xₙ₊₁ in a direction toward the adjacent first rectangular region 403a.

Next, in a step S417, as shown in FIG. 18D, portions 405b where the region 404b increased in the step S416 and the remaining first rectangular regions 403a are overlapped are extracted, and the total area A_{n,m} of the extracted portions 405b is obtained. Thereafter, as shown in FIG. 18E, the portions 405b extracted in the step S417 are reclassified as the calculated region 406. In other words, the extracted portions 405b are excluded from the first rectangular regions 403a.

Thereafter, while incrementing m by 1 until the value m becomes equal to a given value t, the procedures of the step S414 through the step S417 are repeatedly carried out.

Next, when the value m becomes equal to the given value t, a total area A_{n,t+1} of the remaining first rectangular regions 403a is obtained, and the remaining first rectangular regions 403a are reclassified as the calculated region 406. In other words, all the first rectangular regions 403a extracted in the step S402 are excluded from the target region at this point. In the case where the portions already used for calculating the total areas A_{n,m} have not been excluded from the first rectangular regions 403a to be reclassified as the calculated region 406 at this point, after extracting, in a step S418, all the space regions 402 in contact with the first rectangular regions 403a extracted in the step S402, and a sum of the already extracted adjacent regions Z_{n,0}, Z_{n,1}, . . . and Z_{n,t} is excluded in a step S419 from the regions extracted in the step S418. Thereafter, in a step S420, the width of a remaining region obtained in the step S419 is increased by the width Xₙ₊₁ in a direction toward the adjacent first rectangular region 403a, portions where the region increased in the step S420 and the first rectangular regions 403a are overlapped are extracted in a step S421, and the area of the extracted region is defined as the total area A_{n,t+1}.

Next, (n+1)th rectangular regions having a width not smaller than the width Xₙ and smaller than the width Xₙ₊₁, corresponding to a sum of the width Xₙ and the pitch ΔX are extracted from the target region (namely, the line regions 401 excluding the calculated region 406). Then, procedures for successively obtaining total areas A_{n,0} through A_{n,t+1} related to the (n+1)th rectangular regions and excluding the (n+1)th rectangular regions to be reclassified as the calculated region 406 in the same manner as in the steps S411 through S421 are repeatedly carried out while incrementing n from 1 by 1 until n becomes equal to a given value (u−1).

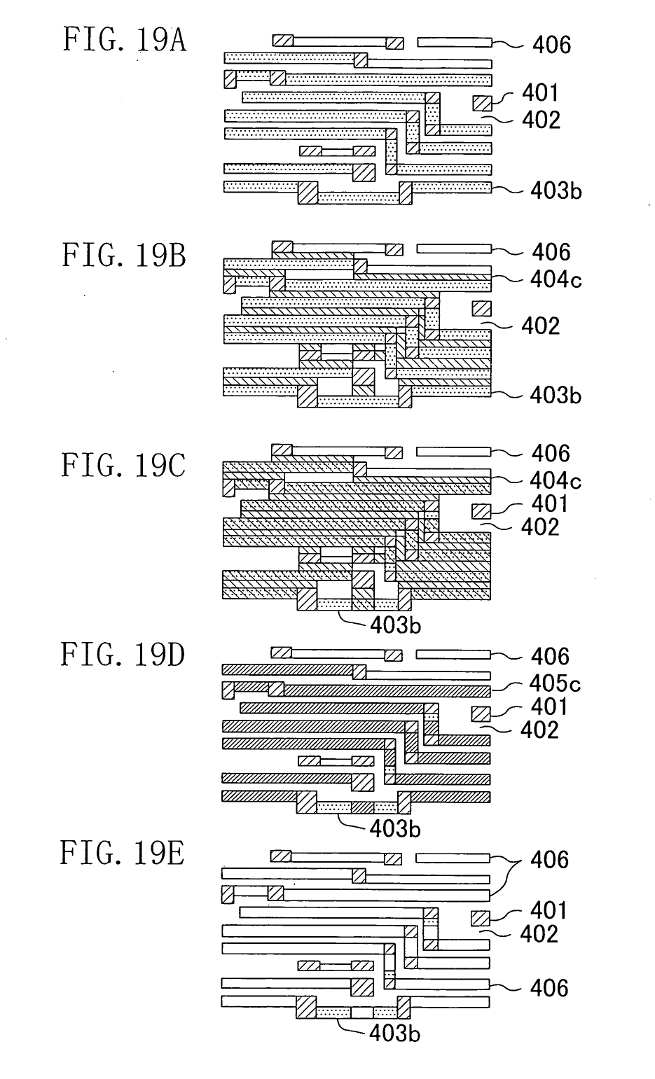

Specifically, after setting the value n to n+1, if n≦u−1, in the step S403, as shown in FIG. 19A, (n+1)th rectangular regions 403b having a width not smaller than the width Xₙ and smaller than the width Xₙ₊₁ corresponding to a sum of the width Xₙ and the pitch ΔX are extracted from each line region 401 (whereas excluding the calculated region 406) included in the target region (whereas the number of extracted (n+1)th rectangular regions 403b may be one or no region may be extracted). Then, the value m is set to 0, and as shown in FIGS. 19B through 19E, the (n+1)th rectangular regions 403b are subjected to the procedures of the steps S411 through S413 having been performed on the first rectangular regions 403a. Specifically, as shown in FIG. 19B, a region 404c having the minimum space width Yₘᵢₙ=Y₀ is extracted from a portion of the space regions 402 in contact with the (n+1)th rectangular regions 403b extracted in the step S403. Next, as shown in FIG. 19C, the width of the region 404c is increased by the width Xₙ₊₁ in a direction toward the adjacent (n+1)th rectangular region 403b. Then, as shown in FIG. 19D, portions 405c where the increased region 404c and the (n+1)th rectangular regions 403b extracted in the step S403 are overlapped are extracted, and the total area A_{n,m} of the extracted portions 405c (specifically, when n=1 and m=0, a total area A_{1,0} of rectangular regions having a width not smaller than the width X₁ and smaller than the width X₂ and adjacent to a space region 402 with the minimum width Yₘᵢₙ) is obtained. Thereafter, as shown in FIG. 19E, the extracted portions 405c are reclassified as the calculated region 406. In other words, the extracted portions 405c are excluded from the (n+1) th rectangular regions 403b.

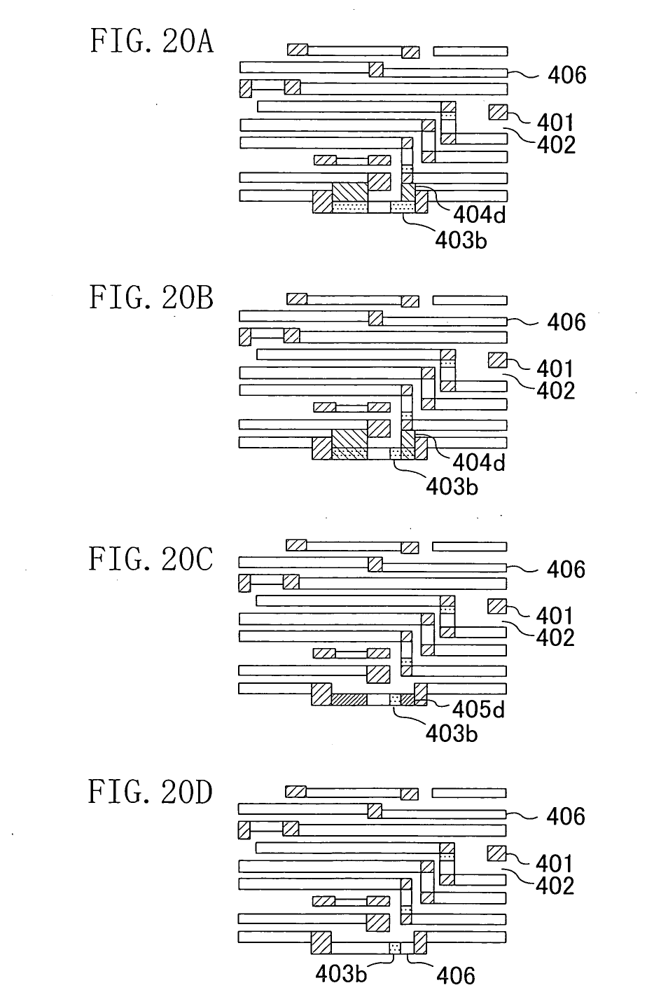

Next, after setting the value m to m+1, the procedures of the steps S414 through S417 are repeatedly performed as shown in FIG. 20A through 20D while incrementing m by 1 until the value m becomes equal to the value t. Specifically, as shown in FIG. 20A, a region 404d having a space width not larger than Yₘ (wherein Yₘ=Yₘ₋₁+ΔY) is extracted from a portion of the space regions 402 in contact with the remaining (n+1) rectangular regions 403a. In the case where the portions already used for calculating the total area A_{n,m} have not been separated from the (n+1)th rectangular regions 403b to be reclassified as the calculated region 406 at this point, a sum of the already extracted regions may be excluded from the region 404d, so as to define a remaining region as the region 404d. Then, as shown in FIG. 20B, the width of the region 404d is increased by the width Xₙ₊₁ in a direction toward the adjacent (n+1) rectangular region 403b. Thereafter, as shown in FIG. 20C, portions 405d where the increased region 404d and the remaining (n+1)th rectangular regions 403b are overlapped are extracted, and the total area A_{n,m} of the extracted portions 405d is obtained. Thereafter, as shown in FIG. 20D, the extracted portions 405b are reclassified as the calculated region 406. In other words, the extracted portions 405d are excluded from the (n+1)th rectangular regions 403b.

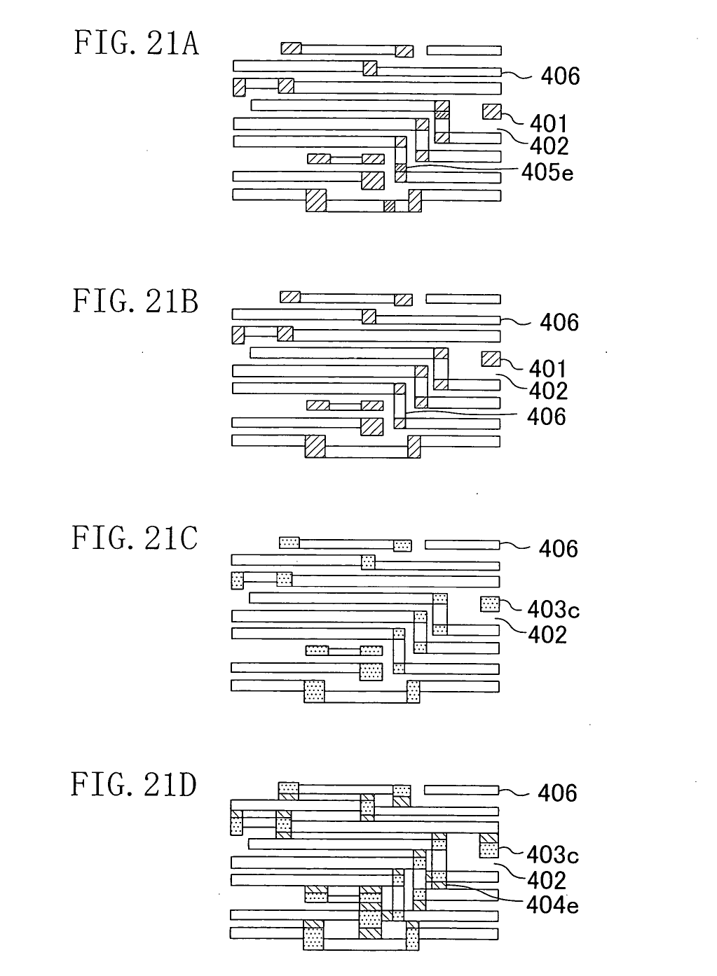

Next, when the value m becomes equal to the value t, as shown in FIG. 21A, a total area A_{n,t+1} of a remaining portion 405e of the (n+1)th rectangular regions 403b is obtained, and the remaining (n+1)th rectangular regions 403b are reclassified as the calculated region 406 as shown in FIG. 21B. In other words, all the (n+1)th rectangular regions 403b extracted in the step S403 are excluded from the target region at this point. In the case where the portions already used for calculating the total areas A_{n,m} have not been excluded from the (n+1)th rectangular regions 403b to be reclassified as the calculated region 406 when the value m becomes equal to the value t, the procedures of the steps S418 through S421 are repeatedly carried out. Specifically, after extracting all the space regions 402 in contact with the (n+1)th rectangular regions 403b extracted in the step S403, a sum of already extracted regions is excluded from the extracted regions. Thereafter, the width of a remaining region is increased by the width Xₙ₊₁ in a direction toward the adjacent (n+1)th rectangular region 403b, portions where the increased region and the (n+1)th rectangular regions 403b are overlapped are extracted, and the area of the extracted portions is defined as the total area A_{n,t+1}.

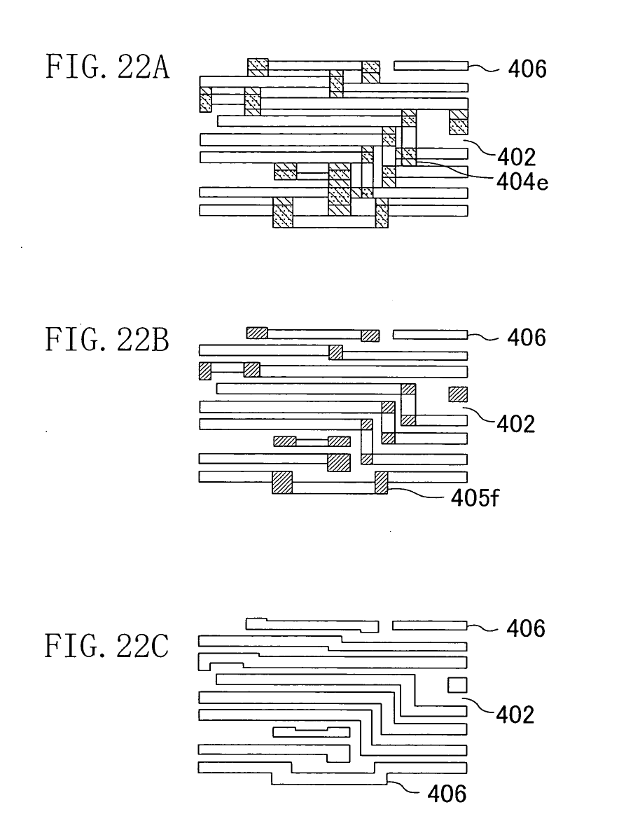

Next, when the value n becomes equal to a value u, in the step S404, all the line regions 401 (excluding the regions classified as the calculated region 406) corresponding to the remaining target region are extracted as the target rectangular regions 403c as shown in FIG. 21C. Thereafter, the value m is set to 0, and the target rectangular regions 403c are subjected to the procedures of the steps S411 through S413 having been performed on the first rectangular regions 403a as shown in FIGS. 21D through 22C. Specifically, first, as shown in FIG. 21D, a region 404e having the minimum space width Yₘᵢₙ=Y₀ is extracted from a portion of the space regions 402 in contact with the target rectangular regions 403c extracted in the step S404. Next, as shown in FIG. 22A, the width of the region 404e is increased by a width Xₙ₊₁ in a direction toward the adjacent target rectangular region 403c. Then, as shown in FIG. 22B, portions 405f where the increased regions 404e and the target rectangular regions 403c extracted in the step S404 are overlapped are extracted, and a total area A_{u,m} of the extracted portions 405f (specifically, when m=0, a total area A_{u,0} of rectangular regions adjacent to a space region 402 with the minimum width Yₘᵢₙ) is obtained. Thereafter, as shown in FIG. 22C, the extracted portions 405f are reclassified as the calculated region 406. In other words, the extracted portions 405f are excluded from the target rectangular regions 403c.

Next, after setting the value m to m+1, the procedures of the steps S414 through S417 are repeatedly carried out while incrementing m by 1 until the value m becomes equal to the value t. Specifically, a region having a space width not larger than the width Yₘ (wherein Yₘ=Yₘ₋₁+ΔY) is extracted from a portion of the space regions 402 in contact with the remaining target rectangular regions 403c. In the case where the portions already used for calculating the total area A_{u,m} have not been separated from the target rectangular regions 403c to be reclassified as the calculated region 406 at this point, a sum of the already extracted regions are excluded from the extracted region. Thereafter, the width of the extracted region is increased by the width Xᵤ₊₁ in a direction toward the adjacent target rectangular region 403c. Next, portions where the increased region and the remaining target rectangular regions 403c are overlapped are extracted, and the total area A_{u,m} of the extracted portions is obtained. Thereafter, the extracted portions are reclassified as the calculated region 406. In other words, the extracted portions are excluded from the target rectangular regions 403c.

Next, when the value m becomes equal to the value t, a total area A_{u,t+1} of the remaining target rectangular regions 403c is obtained, and the remaining target rectangular regions are reclassified as the calculated region 406. In other words, all the target rectangular regions 403c extracted in the step S404 are excluded from the target region at this point. In the case where the portions already used for calculating the total areas A_{u,m} have not been excluded from the target rectangular regions 403c to be reclassified as the calculated region 406 when the value m becomes equal to the value t, the procedures of the steps S418 through S421 are repeatedly carried out. Specifically, after extracting all the space regions 402 in contact with the target rectangular regions 403c extracted in the step S404, a sum of already extracted regions is excluded from the extracted regions. Thereafter, the width of a remaining region is increased by the width Xₙ₊₁ in a direction toward the adjacent target rectangular region 403c, portions where the increased region and the target rectangular regions 403c are overlapped are extracted, and the area of the extracted region is defined as the total area A_{u,t+1}.

Next, when the value n becomes equal to u+1, the total areas A_{0,0}, A_{0,1}, . . . and A_{u,t+1} are used for calculating the critical area in a step S405. The specific method for calculating the critical area will be described later.

Then, in a step S406, information of the critical area calculated in the step S405 (i.e., the critical area information 104) is output to a file on the storage device 102, and thus, the pattern analysis processing is completed.

Now, an example of the critical area calculation method using the total areas A_{0,0}, A_{0,1}, . . . , and A_{u,t+1} performed in the step S405 will be described in detail. It is noted that the critical area calculation method using the total areas A_{0,0}, A_{0,1}, . . . , and A_{u,t+1} is not limited to the following example.

In the step S405, the critical area is calculated by using, for example, Formula 4-2 disclosed in Non-patent document 3 (described in “Background of the Invention”). Specifically, the critical area is calculated by using Formula 4-2, which is used for a critical area in consideration of the interconnect open in Non-patent document 3, by using the total area A_{n,m} of the line regions having a line width not smaller than the width Xₙ and smaller than the width Xₙ₊₁ (=Xₙ+ΔX) and adjacent to a space region having a width not smaller than the width Yₘ and smaller than the width Yₘ₊₁.

In Formula 4-2, x is the size of a defect, and 1=(Xₙ+Xₙ₊₁)/2, s=(Yₘ+Yₘ₊₁)/2 and L=A_{n,m}/l.

When the critical area, that is, the critical area in consideration of the open failure, is thus calculated, a yield in consideration of the interconnect open can be calculated by assigning the critical area in a known yield calculation formula (such as Formula 3 described in “Background of the Invention”).

In the above description, the critical area in consideration of the open failure is calculated by carrying out the procedures of the step S401 through the step S406 and the step S411 through the step S421 on the target region, namely, the plural line regions 401 corresponding to the interconnects. Similarly, when the plural space regions 402 corresponding to the regions between interconnects are dealt with as the target region for carrying out the procedures of the step S401 through the step S406 and the step S411 through the step S421, a critical area in consideration of interconnect short-circuit can be calculated.

According to Embodiment 4, the actual pattern layout data 103 including the plural line regions 401 and the plural space regions 402 can be dealt with as simple combinations of a plurality of rectangular patterns respectively having different widths (namely, the first rectangular regions 403a, etc.). In other words, in consideration of the relationship between the width of each rectangular pattern (more accurately, the width of the interconnect space) and the size of a defect such as a particle, the critical area can be easily and accurately calculated by using the total areas of the respective rectangular patterns. Furthermore, although it is assumed that the interconnect width is equal to the space width between interconnects (namely, w=s) in Formula 4-2 in Embodiment 1 or 2, such assumption is not employed but the critical area is calculated by using the actual interconnect width and the actual space width between the interconnects in the pattern layout in this embodiment. Specifically, in calculating a critical area with respect to the line regions 401, the critical area is calculated also in consideration of the widths of the space regions 402. Therefore, as compared with Embodiments 1 and 2, the calculated critical area is more improved in the accuracy. Accordingly, when the critical area thus obtained is used for calculating a yield, a highly precise yield very close to the yield of actual products can be rapidly calculated even with respect to complicated patterns of a highly integrated LSI.

Moreover, in Embodiment 4, the pitch ΔX or ΔY is preferably increased as the line width Xₙ or the space width Yₘ is increased. Thus, the calculation speed of the critical area calculation can be increased without degrading the calculation accuracy. In this case, when the pitch ΔX or ΔY is kept at a constant value as far as the line width Xₙ or the space width Yₘ falls within a given range, the calculation speed can be further increased. Specifically, with respect to the line width Xₙ, in the case where the width Xₙ is smaller than a value twice as large as the minimum width Xₘᵢₙ, the pitch ΔX is set to a value (substantially) 1/10 as large as the minimum width Xₘᵢₙ. In the case where the width Xₙ is not smaller than the value twice as large as the minimum width Xₘᵢₙ and smaller than a value five times as large as the minimum width Xₘᵢₙ, the pitch ΔX is set to a value (substantially) ⅕ as large as the minimum width Xₘᵢₙ. In the case where the width Xₙ is not smaller than the value five times as larger as the minimum width Xₘᵢₙ and smaller than a value ten times as large as the minimum width Xₘᵢₙ, the pitch ΔX is set to a value (substantially) equivalent to the minimum width Xₘᵢₙ. In the case where the width Xₙ is not smaller than the value ten times as large as the minimum width Xₘᵢₙ and smaller than a value a hundred times as large as the minimum width Xₘᵢₙ, the pitch ΔX is set to a value (substantially) ten times as large as the minimum width Xₘᵢₙ. Also, with respect to the space width Yₘ, in the case where the width Yₘ is smaller than a value twice as large as the minimum width Yₘᵢₙ, the pitch ΔY is set to a value (substantially) 1/10 as large as the minimum width Yₘᵢₙ. In the case where the width Yₘ is not smaller than the value twice as large as the minimum width Yₘᵢₙ and smaller than a value five times as large as the minimum width Yₘᵢₙ, the pitch ΔY is set to a value (substantially) ⅕ as large as the minimum width Yₘᵢₙ. In the case where the width Yₘ is not smaller than the value five times as larger as the minimum width Yₘᵢₙ and smaller than a value ten times as large as the minimum width Yₘᵢₙ, the pitch ΔY is set to a value (substantially) equivalent to the minimum width Yₘᵢₙ. In the case where the width Yₘ is not smaller than the value ten times as large as the minimum width Yₘᵢₙ and smaller than a value a hundred times as large as the minimum width Yₘᵢₙ, the pitch ΔY is set to a value (substantially) ten times as large as the minimum width Yₘᵢₙ.

Furthermore, in Embodiment 4, in order to, for example, further increase the calculation speed for the critical area, different values from those described in the above description may be used as the pitches ΔX and ΔY. Also, the given value u (namely, the maximum line width Xᵤ (=Xₘₐₓ) used in the critical area calculation) and the given value t (namely, the maximum space width Yₜ (=Yₘₐₓ) used in the critical area calculation) may be appropriately selected in accordance with the maximum line width, the maximum space width and the pitches ΔX and ΔY of a layout pattern in which the critical area is to be calculated.

The pattern analysis method of Embodiment 4 preferably further includes, between the first step S401 and the second step S402, a step of excluding, from the target region for calculating the critical area, a region where a dummy pattern of the pattern layout data is disposed. Thus, the critical area can be precisely calculated with the dummy pattern not related to the yield of the actual products excluded, and therefore, a more highly precise yield close to the yield of the actual products can be calculated by using the critical area.

### EMBODIMENT 5

Now, a pattern analysis apparatus and a pattern analysis method according to Embodiment 5 of the invention will be described with reference to the accompanying drawings by exemplifying a case where the number of different-node near vias (that is, vias each of which is spaced from an adjacent via by a distance not larger than a given value and has an upper interconnect and a lower interconnect connected thereto being different nodes from the adjacent via) working as contacts for electrically connecting lower interconnects and upper interconnects to each other in a multilayer interconnect structure of an LSI is calculated. It is noted that a yield YRV depending upon contact failure between vias can be obtained by assigning the number of different-node near vias obtained in this embodiment in, for example, Formula 6 (described in “Background of the Invention”) as the number N of vias. In other words, in order to calculate the influence of the short-circuit failure between vias on the yield, it is necessary to obtain the total number of different-node near vias. In the case where short-circuit failure between contacts is considered in stead of the short-circuit failure between vias, a lower interconnect used with respect to the vias is replaced with, for example, a diffusion layer of a transistor, or an upper interconnect used with respect to the vias is replaced with, for example, an electrode of a capacitative element. Furthermore, in the process of a 0.13 μm rule, a via distance that may cause a short-circuit (namely, leakage) between vias (corresponding to the aforementioned given value) is approximately 0.2 μm or less, and a contact distance that may cause a short-circuit (namely, leakage) between contacts (corresponding to the aforementioned given value) is approximately 0.3 μm or less. Furthermore, in the process of a 0.1 μm rule, a via distance that may cause a short-circuit (namely, leakage) between vias (corresponding to the aforementioned given value) is approximately 0.15 μm or less, and a contact distance that may cause a short-circuit (namely, leakage) between contacts (corresponding to the aforementioned given value) is approximately 0.25 μm or less.

An example of the architecture of the pattern analysis apparatus of Embodiment 5 is the same as that of Embodiment 3 shown in FIG. 8. Specifically, as shown in FIG. 8, the pattern analysis apparatus 300 of this embodiment includes a central control unit (CPU) 301 and a storage device 302 for storing pattern layout data 303 and different-node near via number information 304 (whereas the single connection via number information 304 of FIG. 8 is read as the different-node near via number information 304 in this embodiment). As operating means, the CPU 301 reads the pattern layout data 303 from the storage device 302 and executes the pattern analysis method of this embodiment described below by using the read pattern layout data 303. Also, as outputting means, the CPU 301 outputs, to the storage device 302, the different-node near via number information 304 obtained as a result of executing the pattern analysis method of this embodiment.

Needless to say, the architecture of the pattern analysis apparatus used for executing the pattern analysis method of this embodiment described below is not limited to that shown in FIG. 8.

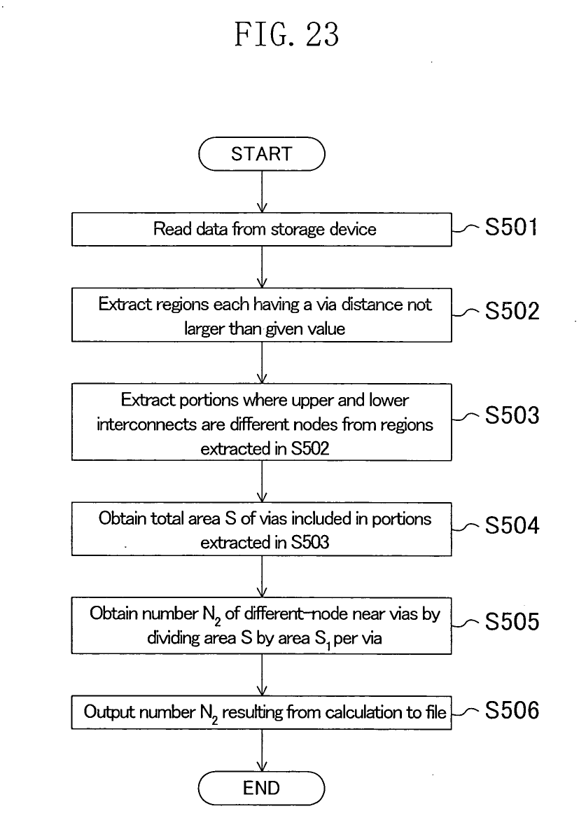

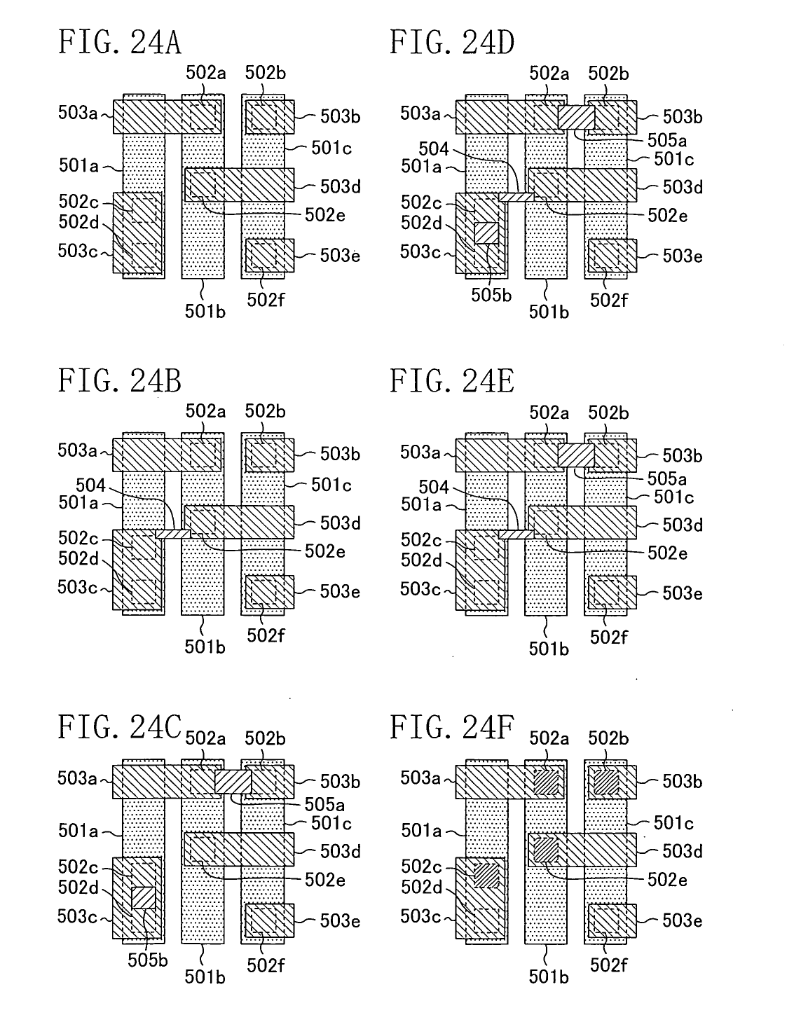

FIG. 23 is a flowchart for the pattern analysis method according to Embodiment 5 using the pattern analysis apparatus shown in FIG. 8, and FIGS. 24A through 24F are interconnect pattern layout diagrams for explaining respective steps of the flowchart of FIG. 23.

First, in a first step S501, the pattern layout data 303, which is specifically mask data used as layout data of a specific pattern, is read as CAD data from the storage device 302 corresponding to a memory region of a computer. The pattern layout data read at this point includes pattern layout data of lower interconnects and upper interconnects included in a multilayer interconnect structure (namely, interconnect pattern layout data) and pattern layout data of vias for connecting the lower interconnects and the upper interconnects to each other (namely, contact pattern layout data). The interconnect pattern layout data includes a plurality of line regions corresponding to the interconnects and a plurality of space regions corresponding to regions between the interconnects. Also, although it is assumed in this embodiment that each via is in a rectangular shape in a plan view, it goes without saying that the plan shape of each via is not particularly specified.

FIG. 24A shows a layout pattern to be analyzed in this embodiment in which the interconnect pattern layout data of the upper and lower interconnects and the contact pattern layout data are overlapped. Specifically, as shown in FIG. 24A, lower interconnects 501a, 501b and 501c corresponding to different nodes and upper interconnects 503a, 503b, 503c, 503d and 503e corresponding to different nodes are connected to one another through a plurality of vias 502a, 502b, 502c, 502d, 502e and 502f. Specifically, the lower interconnect 501a and the upper interconnect 503c are connected to each other through the vias 502c and 502d. The lower interconnect 501b and the upper interconnect 503a are connected to each other through the via 502a. The lower interconnect 501b and the upper interconnect 503d are connected to each other through the via 502e. The lower interconnect 501c and the upper interconnect 503b are connected to each other through the via 502b. The lower interconnect 501c and the upper interconnect 503e are connected to each other through the via 502f In this case, via pairs mutually corresponding to different-node near vias are a pair of the vias 502a and 502b and a pair of the vias 502c and 502e. Between such different-potential near vias, there may arise short-circuit failure derived from a crack described in “Background of the Invention”.

Next, in a second step S502, out of the respective vias 502, near vias each near to another via at a distance not larger than a given value are extracted. Specifically, as shown in FIG. 24B, a region sandwiched between a pair of vias having opposing apexes spaced from each other by a distance not larger than the given value (that is, a region 504 sandwiched between one apex of the via 502c and one apex of the via 502e in this embodiment) is extracted. Also, as shown in FIG. 24C, a region sandwiched between a pair of vias having opposing sides spaced from each other by a distance not larger than the given value (that is, a region 505a sandwiched between one side of the via 502a and one side of the via 502b and a region 505b sandwiched between one side of the via 502c and one side of the via 502d in this embodiment) is extracted. Thus, in the second step S502, the vias 502c and 502e, the vias 502a and 502b and the vias 502c and 502d are extracted as the pairs of vias near to each other. In other words, as shown in FIG. 24D, the regions 504, 505a and 505b sandwiched between the pairs of vias near to each other are extracted in the second step S502.

Next, in a third step S503, different-node near vias (namely, vias each having an upper interconnect and a lower interconnect connected thereto being different nodes from a paired adjacent via (namely, the other via out of the pair)) are extracted from all the near vias extracted in the second step S502. Specifically, as shown in FIG. 24E, from the regions 504, 505a and 505b extracted in the second step S502, a region in which both the upper interconnects connected to the via pair sandwiching the region and the lower interconnects connected to the via pair sandwiching the region are different nodes (that is, the regions 505a and 504 in this embodiment) is extracted. Specifically, in the third step S503, the vias 502a and 502b and the vias 502c and 502e are extracted as the different-node near vias.

Next, in a fourth step S504, a total area S of all the different-node near vias extracted in the third step S503 is obtained. Specifically, the total area S of all the vias in contact with the target region (namely, the regions 504 and 505a) extracted in the third step S503, namely, a sum of the areas of the vias 502a, 502b, 502c and 502e as shown in FIG. 24F, is obtained.

Then, in a fifth step S505, the total area S is divided by an area S₁ per via 502, so as to obtain the number N₂ of different-node near vias. At this point, the area S₁ per via 502 means a contact area between the via 502 and an interconnect to be connected (namely, the lower interconnect 501 or the upper interconnect 503) on the layout data.

Next, in a sixth step S506, the calculation result obtained in the fifth step S505, namely, information of the number N₂ of different-node near vias (i.e., the different-node near via number information 304) is output to a file on the storage device 302, and thus, the pattern analysis processing is completed.

On the basis of the number N₂ of different-node near vias obtained in the aforementioned manner and, for example, via fraction defective determined by the process (obtained by using, for example, a test pattern), a yield depending upon via failure can be accurately calculated by using, for example, Formula 6.

According to Embodiment 5, out of the vias 502 for connecting the lower interconnects 501 and the upper interconnects 503, different-node near vias, each of which is spaced from an adjacent via by a distance not smaller than the given value and has a lower interconnect 501 and an upper interconnect 503 connected thereto being different nodes from the adjacent via, are extracted. Thereafter, the total area S of all the extracted different-node near vias is obtained, and the total area S is divided by the area S₁ per via, so as to obtain the number N₂ of different-node near vias. Therefore, the total number of vias in which leakage (short-circuit) between vias may occur, namely, the number N₂ of different-node near vias, can be efficiently and accurately calculated. Accordingly, when the number N₂ of different-node near vias thus obtained is used in the yield calculation together with, for example, the via fraction defective determined by the process, a highly precise yield very close to the yield of actual products can be rapidly calculated even with respect to complicated patterns of a highly integrated LSI.

Although the multilayer interconnect pattern described in Embodiment 5 includes two layers of interconnects, also in a multilayer interconnect pattern including three or more layers of interconnects, the number of different-node near vias necessary for the yield calculation can be obtained by repeating similar procedures.

The pattern analysis method of Embodiment 5 preferably further includes, between the first step S501 and the fourth step S504, a step of excluding a region where a dummy pattern is disposed from the respective pattern layout data (that is, the interconnect pattern layout data of the upper and lower interconnects and the contact pattern layout data). Thus, the number of different-node near vias can be precisely calculated with the dummy pattern not related to the yield of the actual products excluded, and therefore, a more highly precise yield close to the yield of the actual products can be calculated by using the number of different-node near vias.

In Embodiment 5, the number of different-node near vias for electrically connecting lower interconnects and upper interconnects to each other in a multilayer interconnect structure of an LSI is calculated. However, it goes without saying that the present invention is applicable to a case where the number of different-node near vias for electrically connecting, for example, diffusion layers of transistors or the like and upper interconnects disposed above or lower interconnects and electrodes or the like of capacitative elements disposed above is calculated.

Furthermore, when a yield calculated in accordance with each of Embodiments 1 through 5 is compared with a yield of actual products, the error is 3% or less in all the embodiments. Thus, it is confirmed that a yield can be accurately estimated on the basis of a pattern layout.

Moreover, although interconnect patterns of a semiconductor device such as an LSI are analyzed in each of Embodiments 1 through 5, the application of the invention is not limited to the interconnect patterns. For example, the present invention is applicable to a diffusion pattern or an insulating film pattern. Furthermore, the present invention is applicable to various types of patterns employed for fabrication a liquid crystal display device, a plasma display device and the like.

1. A pattern analysis method comprising:
a first step of preparing pattern layout data including a plurality of first regions and a plurality of second regions;
a second step of selecting either said plurality of first regions or said plurality of second regions as a target region in which a critical area of said pattern layout data is to be calculated;
a third step of extracting, from said target region, rectangular regions each having a width within a given range;
a fourth step of obtaining a total area of said rectangular regions; and
a fifth step of calculating said critical area by using said total area.

2. A pattern analysis method comprising:
a first step of preparing pattern layout data including a plurality of first regions and a plurality of second regions;
a second step of selecting either said plurality of first regions or said plurality of second regions as a target region in which a critical area of said pattern layout data is to be calculated and defining the rest of said plurality of first regions and said plurality of second regions not selected as a non-target region;
a third step of extracting, from said target region, rectangular regions each having a width within a given range;
a fourth step of extracting an adjacent region having a width within a given range from a portion of said non-target region in contact with said rectangular regions;
a fifth step of increasing the width of said adjacent region by a given width in a direction toward an adjacent one of said rectangular regions;
a sixth step of extracting portions where said adjacent region having been increased in the width and said rectangular regions are overlapped and obtaining a total area of said extracted portions; and
a seventh step of calculating said critical area by using said total area.

3. A pattern analysis method comprising:
a first step of preparing pattern layout data including a plurality of first regions and a plurality of second regions;
a second step of selecting either said plurality of first regions or said plurality of second regions as a target region in which a critical area of said pattern layout data is to be calculated;
a third step of extracting, from said target region, first rectangular regions each having a width not smaller than a minimum width Xₘᵢₙ of said target region and smaller than a width Xi corresponding to a sum of said width Xₘᵢₙ and a pitch ΔX;
a fourth step of obtaining a total area SI of said first rectangular regions;
a fifth step of reclassifying said first rectangular regions as a separate region from said target region after the fourth step;
a sixth step, performed after the fifth step, of repeatedly performing procedures for extracting, from said target region, (n+1)th rectangular regions each having a width not smaller than a width Xₙ (wherein n is a natural number of 1 through t) and smaller than a width Xₙ₊₁ corresponding to a sum of said width Xₙ and said pitch ΔX, obtaining a total area Sₙ₊₁ of said (n+1)th rectangular regions, and reclassifying said (n+1)th rectangular regions as a separate region from said target region while incrementing n by 1 from 1 until said width Xₙ becomes equal to a given value Xₜ;
a seventh step of obtaining a total area Sₜ₊₁ of remaining portions of said target region after the sixth step; and
an eighth step of calculating said critical area by using said total areas after the seventh step.

4. The pattern analysis method of claim 3,
wherein said pitch ΔX is increased as said width Xₙ is increased in the sixth step.

5. The pattern analysis method of claim 4,
wherein said pitch ΔX is kept at a constant value as far as said width Xₙ falls within a given range in the sixth step.

6. The pattern analysis method of claim 5,
wherein, in the sixth step, when said width Xₙ is smaller than a value twice as large as said minimum width Xₘᵢₙ, said pitch ΔX is set to a value 1/10 as large as said minimum width Xₘᵢₙ, when said width Xₙ is not smaller than the value twice as large as said minimum width Xₘᵢₙ and smaller than a value five times as large as said minimum width Xₘᵢₙ, said pitch ΔX is set to a value ⅕ as large as said minimum width Xₘᵢₙ, when said width Xₙ is not smaller than the value five times as large as said minimum width Xₘᵢₙ and smaller than a value ten times as large as said minimum width Xₘᵢₙ, said pitch ΔX is set to a value equivalent to said minimum width Xₘᵢₙ, and when said width Xₙ is not smaller than the value ten times as large as said minimum width Xₘᵢₙ and smaller than a value a hundred times as large as said minimum width Xₘᵢₙ, said pitch ΔX is set to the value ten times as large as said minimum width Xₘᵢₙ.

7. The pattern analysis method of claim 3, further comprising, between the second step and the third step, a step of excluding, from said target region, a region where a dummy pattern of said pattern layout data is disposed.

8. A pattern analysis method comprising:
a first step of preparing pattern layout data including a plurality of first regions and a plurality of second regions;
a second step of selecting either said plurality of first regions or said plurality of second regions as a target region in which a critical area of said pattern layout data is to be calculated and defining the rest of said plurality of first regions and said plurality of second regions not selected as a non-target region;
a third step of extracting, from said target region, first rectangular regions each having a width not smaller than a minimum width Xₘᵢₙ of said target region and smaller than a width X₁ corresponding to a sum of said width Xₘᵢₙ and a pitch ΔX;
a fourth step of extracting a first adjacent region Z_{0,0} having a minimum width Yₘᵢₙ of said non-target region from a portion of said non-target region in contact with said first rectangular regions;
a fifth step of increasing a width of said first adjacent region Z_{0,0} by said width X₁ in a direction toward an adjacent one of said first rectangular regions;
a sixth step of extracting portions where said first adjacent region Z_{0,0} having been increased in the width and said first rectangular regions are overlapped and obtaining a total area A_{0,0} of said extracted portions;
a seventh step of reclassifying said extracted portions as a separate region from said first rectangular regions after the sixth step;
an eighth step, performed after the seventh step, of repeatedly performing procedures for extracting, from a portion of said non-target region in contact with said first rectangular regions, a mth adjacent region Z_{0,m} having a width not larger than a width Yₘ corresponding to a sum of a width Yₘ₋₁ of said non-target region (wherein m is a natural number; and a width Y₀ corresponds to said minimum width Yₘᵢₙ) and a pitch ΔY, increasing a width of said mth adjacent region Z_{0,m} by said width X₁ in a direction toward an adjacent one of said first rectangular regions, extracting portions where said mth adjacent region Z_{0,m} having been increased in the width and said first rectangular regions are overlapped, obtaining a total area A_{0,m} of said extracted portions, and reclassifying said extracted portions as a separate region while incrementing m by 1 from 1 until m becomes equal to a given value t;
a ninth step of obtaining a total area A_{0,t+1} of remaining portions of said first rectangular regions after the eighth step;
a tenth step, performed after the ninth step, of repeatedly performing procedures for extracting, from said target region, (n+1)th rectangular regions each having a width not smaller than a width Xₙ (wherein n is a natural number) and smaller than a width Xₙ₊₁ corresponding to a sum of said width Xₙ and said pitch ΔX and successively obtaining total areas A_{n,0} through A_{n,t+1} of said (n+1)th rectangular regions in a similar manner as in the fourth through ninth steps while incrementing n by 1 from 1 until n becomes equal to a given value (u−1);
an eleventh step, performed after the tenth step, of successively obtaining total areas A_{u,0} through A_{u,t+1} of remaining portions of said target region in a similar manner as in the fourth through ninth steps; and
a twelfth step of calculating said critical area by using said total areas after the eleventh step.

9. The pattern analysis method of claim 8,
wherein said pitch ΔX is increased as said width Xₙ is increased in the tenth step, and
said pitch ΔY is increased as said width Yₘ is increased in the eighth step.

10. The pattern analysis method of claim 9,
wherein said pitch ΔX is kept at a constant value as far as said width Xₙ falls within a given range in the tenth step, and
said pitch ΔY is kept at a constant value as far as said width Yₘ falls within a given range in the eighth step.

11. The pattern analysis method of claim 10,
wherein, in the tenth step, when said width Xₙ is smaller than a value twice as large as said minimum width Xₘᵢₙ, said pitch ΔX is set to a value 1/10 as large as said minimum width Xₘᵢₙ, when said width Xₙ is not smaller than the value twice as large as said minimum width Xₘᵢₙ and smaller than a value five times as large as said minimum width Xₘᵢₙ, said pitch ΔX is set to a value ⅕ as large as said minimum width Xₘᵢₙ, when said width Xₙ is not smaller than the value five times as large as said minimum width Xₘᵢₙ and smaller than a value ten times as large as said minimum width Xₘᵢₙ, said pitch ΔX is set to a value equivalent to said minimum width Xₘᵢₙ, and when said width Xₙ is not smaller than the value ten times as large as said minimum width Xₘᵢₙ and smaller than a value a hundred times as large as said minimum width Xₘᵢₙ, said pitch ΔX is set to the value ten times as large as said minimum width Yₘᵢₙ, and
in the eight step, when said width Yₘ is smaller than a value twice as large as said minimum width Yₘᵢₙ, said pitch ΔY is set to a value 1/10 as large as said minimum width Yₘᵢₙ, when said width Yₘ is not smaller than the value twice as large as said minimum width Yₘᵢₙ and smaller than a value five times as large as said minimum width Yₘᵢₙ, said pitch ΔY is set to a value ⅕ as large as said minimum width Yₘᵢₙ, when said width Yₘ is not smaller than the value five times as large as said minimum width Yₘᵢₙ and smaller than a value ten times as large as said minimum width Yₘᵢₙ, said pitch ΔY is set to a value equivalent to said minimum width Yₘᵢₙ, and when said width Yₘ is not smaller than the value ten times as large as said minimum width Yₘᵢₙ and smaller than a value a hundred times as large as said minimum width Yₘᵢₙ, said pitch ΔY is set to the value ten times as large as said minimum width Yₘᵢₙ.

12. The pattern analysis method of claim 8, further comprising, between the second step and the third step, a step of excluding, from said target region, a region in which a dummy pattern of said pattern layout data is disposed.

13. A pattern analysis apparatus comprising:
a storage device for storing, as CAD data, mask data used as pattern layout data for which a critical area is to be obtained;
operating means for executing the pattern analysis method of claim 3 by using said mask data read from said storage device; and
outputting means for outputting information of said critical area obtained by said operating means.

14. A pattern analysis apparatus comprising:
a storage device for storing, as CAD data, mask data used as pattern layout data for which a critical area is to be obtained;
operating means for executing the pattern analysis method of claim 8 by using said mask data read from said storage device; and
outputting means for outputting information of said critical area obtained by said operating means.

15. A pattern analysis method for calculating a number of vias to be used in yield calculation in consideration of contact failure between multilayered interconnects, comprising:
a first step of preparing first interconnect pattern layout data and second interconnect pattern layout data that are respectively pattern layouts of a first interconnect disposed in a lower layer and a second interconnect disposed in an upper layer of said multilayered interconnects and contact pattern layout data that is a pattern layout of vias for connecting said first interconnect and said second interconnect to each other;
a second step of extracting overlap regions in each of which a line portion of said first interconnect of said first interconnect pattern layout data and a line portion of said second interconnect of said second interconnect pattern layout data are overlapped;
a third step of extracting, from said overlap regions extracted in the second step, target overlap regions each including merely one of said vias;
a fourth step of obtaining a total area S of said vias included in each of said target overlap regions extracted in the third step; and
a fifth step of obtaining a number N₁ of single connection vias by dividing said total area S by an area S₁ per via.

16. The pattern analysis method of claim 15,
wherein said multilayered interconnects further include a third interconnect disposed below said first interconnect,
in the fourth step, overlap states between other vias for connecting said first interconnect and said third interconnect to each other and said vias included in said target overlap regions are classified into N (wherein N is a natural number) kinds of overlap states and N kinds of total areas S are obtained respectively in accordance with the N kinds of overlap states, and
in the fifth step, N kinds of numbers N₁ of single connection vias are obtained respectively in accordance with the N kinds of overlap states by dividing the N kinds of total areas S respectively by said area S₁ per via.

17. The pattern analysis method of claim 15, further comprising, between the first step and the fourth step, a step of excluding a region where a dummy pattern is disposed from said interconnect and contact pattern layout data, said overlap regions or said target overlap regions.

18. A pattern analysis method for calculating a number of vias to be used in yield calculation in consideration of contact failure between multilayered interconnects, comprising:
a first step of preparing first interconnect pattern layout data and second interconnect pattern layout data that are respectively pattern layouts of first interconnects disposed in a lower layer and second interconnects disposed in an upper layer of said multilayered interconnects and contact pattern layout data that is a pattern layout of vias for connecting said first interconnects and said second interconnects to each other;
a second step of extracting, from said vias of said contact pattern layout data, near vias each near to another via spaced at a distance smaller than a given value;
a third step of extracting, from said near vias extracted in the second step, different-node near vias each having a first interconnect and a second interconnect connected thereto being different nodes from another via near to said near vias;
a fourth step of obtaining a total area S of said different-node near vias extracted in the third step; and
a fifth step of obtaining a number N₂ of different-node near vias by dividing said total area S by an area S₁ per via.

19. The pattern analysis method of claim 18, further comprising, between the first step and the fourth step, a step of excluding a region where a dummy pattern is disposed from each said pattern layout data.

20. A pattern analysis apparatus comprising:
a storage device for storing, as CAD data, mask data used as pattern layout data for which a yield in consideration of contact failure between multilayered interconnects is to be calculated;
operating means for executing the pattern analysis method of claim 15 by using said mask data read from said storage device; and
outputting means for outputting information of the number of single connection vias obtained by said operating means.

21. A pattern analysis apparatus comprising:
a storage device for storing, as CAD data, mask data used as pattern layout data for which a yield in consideration of contact failure between multilayered interconnects is to be calculated;
operating means for executing the pattern analysis method of claim 18 by using said mask data read from said storage device; and
outputting means for outputting information of the number of different-node near vias obtained by said operating means.
